(19) United States
(12) Patent Application Publication
(10) Pub. No.: US 2017/0134852 A1
(43) Pub. Date: May 11, 2017

(54) ELECTRONIC DEVICE FOR OUTPUTTING AUDIO SIGNAL AND OUTPUT DEVICE CONNECTED THERETO

(71) Applicant: SAMSUNG ELECTRONICS CO., LTD., Suwon-si (KR)

(72) Inventors: Gi Hoon LEE, Suwon-si (KR); Jae Hwan LEE, Anyang-si (KR); Byeng Sang JUNG, Suwon-si (KR)

(21) Appl. No.: 15/346,168

(22) Filed: Nov. 8, 2016

(30) Foreign Application Priority Data
Nov. 10, 2015 (KR) 10-2015-0157470

(51) Int. Cl. H04R 3/00; H04R 29/00

(52) U.S. Cl. CPC H04R 3/00; H04R 29/00; H04R 2420/05; H04R 2420/01

(57) ABSTRACT

An electronic device is provided which includes an audio jack that receives an audio plug comprising a plurality of terminals and a plurality of insulating members arranged among the plurality of terminals, the audio plug comprises a plurality of contacts that are capable of contacting the plurality of terminals or the plurality of insulating members, a circuit that is electrically connected with the plurality of contacts and configured to send an audio signal to the audio plug, and a processor configured to control the circuit, wherein at least one of the plurality of contacts is electrically connected with a ground and is configured to contact one of the plurality of insulating members of the audio plug if the audio plug is matched with the audio jack.

### CROSS-REFERENCE TO RELATED APPLICATION

This application is based on and claims priority under 35 U.S.C. §119 to a Korean patent application filed on Nov. 10, 2015 in the Korean Intellectual Property Office and assigned Serial number 10-2015-0157470, the disclosure of which is incorporated by reference herein in its entirety.

### TECHNICAL FIELD

The present disclosure relates generally to a receptacle of an electronic device and a structure of a connector of an output device.

### BACKGROUND

With the development of electronic technologies, various types of electronic products are being developed and distributed. In particular, nowadays, an electronic device such as a smartphone and a tablet PC generally includes an audio module that can reproduce a sound source. An electronic device may output an audio signal through an output device such as earphones or the like, which are connected thereto.

The output device may receive an unbalanced audio signal or a balanced audio signal from the electronic device and may output the received signal in the form of a sound wave. A connector of the output device may be inserted into an audio jack of the electronic device. The electronic device may transfer the unbalanced audio signal and/or the balanced audio signal to the connector of the output device through the audio jack included in the electronic device.

In the case where one terminal included in the connector contacts two contact units of the electronic device, an audio circuit of the electronic device needs a switch that activates one of the two contact units. In this case, resistance of the switch in the audio circuit may cause degradation in the quality of an audio signal passing through the switch. In particular, in the case where the switch is interposed between a ground and a ground contact unit of the electronic device, a connection state of the ground becomes unstable, thereby making the quality of the audio signal from the output device increasingly degraded.

### SUMMARY

Aspects of the present disclosure address at least the above-mentioned problems and/or disadvantages and to provide various advantages described below. Accordingly, an aspect of the present disclosure is to provide an electronic device that can prevent and/or reduce degradation of audio signal quality by removing a switch between a ground and a ground contact unit of the electronic device and a method thereof.

In accordance with an example aspect of the present disclosure, an electronic device may include: a housing, an opening defined in one surface of the housing, a hole communicating with the opening, a receptacle that is arranged in the interior of the hole and configured to receive any one of a first external connector or a second external connector, and a circuit that is electrically connected with the receptacle, wherein the first external connector includes at least two terminals and a non-conductive member arranged between two terminals of the at least two terminals and has a first width, wherein the second external connector includes at least two terminals and a non-conductive member that is arranged between two terminals of the at least two and has a second width wider than the first width, wherein the receptacle includes a first contact arranged to contact one of the terminals of the first external connector if the first external connector is inserted therein and to contact the non-conductive member of the second external connector if the second external connector is inserted therein, and wherein the first contact is electrically connected with a ground.

In accordance with another example aspect of the present disclosure, an electronic device may include: an audio jack configured to receive an audio plug including a plurality of terminals and a plurality of insulating members arranged among the plurality of terminals and that includes a plurality of contacts that are capable of contacting the plurality of terminals or the plurality of insulating members, a circuit that is electrically connected with the plurality of contacts to send an audio signal to the audio plug, and a processor configured to control the circuit, wherein at least one of the plurality of contacts is electrically connected with a ground and is arranged to contact one of the plurality of insulating members of the audio plug if the audio plug is matched with the audio jack.

In accordance with another example aspect of the present disclosure, an audio output device may include: a housing that includes at least one speaker and is configured to be put in ears of a user, a line that is connected to the housing and includes a wire, and a plug that is electrically connected to the line, wherein the plug includes a member that extends in a lengthwise direction and includes a first end adjacent to the line and a second end opposite to the first end, wherein the member includes a first metal area, a first nonmetal area, a second metal area, a second nonmetal area, a third metal area, a third nonmetal area, and a fourth metal area in order in a direction from the first end to the second end, and wherein a width of the first metal area is larger than a width of the second metal area.

In accordance with another example aspect of the present disclosure, the electronic device may include: an audio jack that receives a first type audio plug capable of receiving a balanced audio signal or a second type audio plug capable of receiving an unbalanced audio signal and that includes a plurality of contact units capable of contacting a plurality of terminals or a plurality of insulating members included in the first type audio plug or the second type audio plug, a circuit that is electrically connected with the plurality of contacts the circuit being configured to send the balanced audio signal or the unbalanced audio signal to an audio plug matched with the audio jack, and a processor configured to control the circuit, wherein the plurality of contacts includes a ground contact electrically connected with a ground, wherein the ground contact is configured to contact one of a plurality of insulating members included in the first type audio plug if the first type audio plug is matched with the audio jack and to contact one of a plurality of terminals included in the second type audio plug if the second type audio plug is matched with the audio jack, and wherein the circuit is configured to provide the balanced audio signal to the first type audio plug if the ground contact contacts one of the plurality of insulating members and to provide the unbalanced audio signal to the second type audio plug if the ground contact contacts one of the plurality of terminals.

In accordance with another example aspect of the present disclosure, an audio signal output method of an electronic device may include: obtaining a signal for measuring impedance of a terminal or an insulating member of an external connector, determining whether a value of the impedance is included in a specific range, based on the signal, and sending a balanced audio signal to the external connector if the value of the impedance is included in the specific range and sending an unbalanced audio signal to the external connector if the value of the impedance is not included in the specific range.

Other aspects, advantages, and salient features of the disclosure will become apparent to those skilled in the art from the following detailed description, which, taken in conjunction with the annexed drawings, discloses various example embodiments of the present disclosure.

### BRIEF DESCRIPTION OF THE DRAWINGS

The above and other aspects, features, and advantages of the present disclosure will be more apparent from the following description, taken in conjunction with the accompanying drawings, in which like reference numerals refer to like elements, and wherein:

FIG. 1 is a diagram illustrating an example electronic device and an output device, according to an example embodiment;

FIG. 2 is a diagram illustrating an example state in which an electronic device and an output device (balanced) are matched, according to an example embodiment;

FIG. 3 is a diagram illustrating an example state in which an electronic device and an output device (unbalanced) are matched, according to an example embodiment;

FIG. 4 is a diagram illustrating an example state in which an electronic device and an output device (balanced) are matched, according to an example embodiment;

FIG. 5 is a diagram illustrating an example state in which an electronic device and an output device (unbalanced) are matched, according to an example embodiment;

FIG. 6 is a diagram illustrating an example state in which an electronic device and an output device (balanced) are matched, according to an example embodiment;

FIG. 7 is a diagram illustrating an example state in which an electronic device and an output device (unbalanced) are matched, according to an example embodiment;

FIG. 8 is a diagram illustrating an example state in which an electronic device and an output device (balanced) are matched, according to an example embodiment;

FIG. 9 is a diagram illustrating an example state in which an electronic device and an output device (unbalanced) are matched, according to an example embodiment;

FIG. 10 is a block diagram illustrating an example configuration of an electronic device that is coupled with an output device outputting a balanced audio signal, according to an example embodiment;

FIG. 11 is a block diagram illustrating an example configuration of an electronic device that is coupled with an output device outputting an unbalanced audio signal, according to an example embodiment;

FIG. 12 is a block diagram illustrating an example configuration of an electronic device that is coupled with an output device outputting a balanced audio signal, according to an example embodiment;

FIG. 13 is a block diagram illustrating an example configuration of an electronic device that is coupled with an output device outputting an unbalanced audio signal, according to an example embodiment;

FIG. 14 is a block diagram illustrating an example configuration of an electronic device that is coupled with an output device outputting a balanced audio signal, according to an example embodiment;

FIG. 15 is a block diagram illustrating an example configuration of an electronic device that is coupled with an output device outputting an unbalanced audio signal, according to an example embodiment;

FIG. 16 is a flowchart illustrating an example audio signal output method of an electronic device according to various example embodiments;

FIG. 17 is a flowchart illustrating an example audio signal output method of an electronic device according to various example embodiments;

FIG. 18 is a diagram illustrating an example electronic device in a network environment according to various example embodiments;

FIG. 19 is a block diagram illustrating an example electronic device according to various example embodiments; and

FIG. 20 is a block diagram illustrating an example program module, according to various example embodiments.

Throughout the drawings, it should be noted that like reference numbers are used to depict the same or similar elements, features, and structures.

### DETAILED DESCRIPTION

Various example embodiments of the present disclosure may be described with reference to accompanying drawings. Accordingly, those of ordinary skill in the art will recognize that modification, equivalent, and/or alternative on the various example embodiments described herein can be variously made without departing from the scope and spirit of the present disclosure. With regard to description of drawings, similar components may be marked by similar reference numerals.

In the disclosure disclosed herein, the expressions “have”, “may have”, “include” and “comprise”, or “may include” and “may comprise” used herein indicate existence of corresponding features (e.g., elements such as numeric values, functions, operations, or components) but do not exclude presence of additional features.

In the disclosure disclosed herein, the expressions “A or B”, “at least one of A or/and B”, or “one or more of A or/and B”, and the like used herein may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The terms, such as “first”, “second”, and the like used herein may refer to various elements of various embodiments of the present disclosure, but do not limit the elements. For example, “a first user device” and “a second user device” indicate different user devices regardless of the order or priority. For example, without departing the scope of the present disclosure, a first element may be referred to as a second element, and similarly, a second element may be referred to as a first element.

It will be understood that when an element (e.g., a first element) is referred to as being “(operatively or communicatively) coupled with/to” or “connected to” another element (e.g., a second element), it can be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there are no intervening element (e.g., a third element).

According to the situation, the expression “configured to” used herein may be used as, for example, the expression “suitable for”, “having the capacity to”, “designed to”, “adapted to”, “made to”, or “capable of”. The term “configured to” does not mean only “specifically designed to” in hardware. Instead, the expression “a device configured to” may refer, for example to a situation in which the device is “capable of” operating together with another device or other components. For example, a “processor configured to perform A, B, and C” may refer, for example, to a dedicated processor (e.g., an embedded processor) for performing a corresponding operation or a generic-purpose processor (e.g., a central processing unit (CPU) or an application processor) which may perform corresponding operations by executing one or more software programs which are stored in a memory device.

Terms used in this description are used to describe various example embodiments of the present disclosure and are not intended to limit the scope of the present disclosure. The terms of a singular form may include plural forms unless otherwise specified. Unless otherwise defined herein, all the terms used herein, which include technical or scientific terms, may have the same meaning that is generally understood by a person skilled in the art. It will be further understood that terms, which are defined in a dictionary and commonly used, may also be interpreted as is customary in the relevant related art and not in an idealized or overly formal detect unless expressly so defined herein in various example embodiments of the present disclosure. In some cases, even if terms are terms which are defined in the description, they may not be interpreted to exclude embodiments of the present disclosure.

An electronic device according to various example embodiments of the present disclosure may include at least one of smartphones, tablet personal computers (PCs), mobile phones, video telephones, electronic book readers, desktop PCs, laptop PCs, netbook computers, workstations, servers, personal digital assistants (PDAs), portable multimedia players (PMPs), Motion Picture Experts Group (MPEG-1 or MPEG-2) Audio Layer 3 (MP3) players, mobile medical devices, cameras, or wearable devices. According to various embodiments, the wearable device may include at least one of an accessory type (e.g., watches, rings, bracelets, anklets, necklaces, glasses, contact lens, or head-mounted-devices (HMDs), a fabric or garment-integrated type (e.g., an electronic apparel), a body-attached type (e.g., a skin pad or tattoos), or an implantable type (e.g., an implantable circuit), or the like, but is not limited thereto.

According to an example embodiment, the electronic device may be a home appliance. The home appliances may include at least one of, for example, televisions (TVs), digital versatile disc (DVD) players, audios, refrigerators, air conditioners, cleaners, ovens, microwave ovens, washing machines, air cleaners, set-top boxes, TV boxes (e.g., Samsung HomeSync™, Apple TV™, or Google TV™), game consoles (e.g., Xbox™ and PlayStation™), electronic dictionaries, electronic keys, camcorders, electronic picture frames, and the like, but is not limited thereto.

According to another example embodiment, the electronic devices may include at least one of medical devices (e.g., various portable medical measurement devices (e.g., a blood glucose monitoring device, a heartbeat measuring device, a blood pressure measuring device, a body temperature measuring device, and the like)), a magnetic resonance angiography (MRA), a magnetic resonance imaging (MRI), a computed tomography (CT), scanners, and ultrasonic devices), navigation devices, global navigation satellite system (GNSS) receivers, event data recorders (EDRs), flight data recorders (FDRs), vehicle infotainment devices, electronic equipment for vessels (e.g., navigation systems and gyrocompasses), avionics, security devices, head units for vehicles, industrial or home robots, automatic teller's machines (ATMs), points of sales (POSs), or internet of things (e.g., light bulbs, various sensors, electric or gas meters, sprinkler devices, fire alarms, thermostats, street lamps, toasters, exercise equipment, hot water tanks, heaters, boilers, and the like), or the like, but is not limited thereto.

According to various example embodiments, the electronic devices may include at least one of parts of furniture or buildings/structures, electronic boards, electronic signature receiving devices, projectors, or various measuring instruments (e.g., water meters, electricity meters, gas meters, or wave meters, and the like), or the like, but is not limited thereto. According to various example embodiments, the electronic device may be one of the above-described devices or a combination thereof. An electronic device according to an example embodiment may be a flexible electronic device. Furthermore, an electronic device according to an example embodiment may not be limited to the above-described electronic devices and may include other electronic devices and new electronic devices according to the development of technologies.

Hereinafter, electronic devices according to an example embodiment of the present disclosure will be described with reference to the accompanying drawings. The term “user” used herein may refer to a person who uses an electronic device or may refer to a device (e.g., an artificial electronic device) that uses an electronic device.

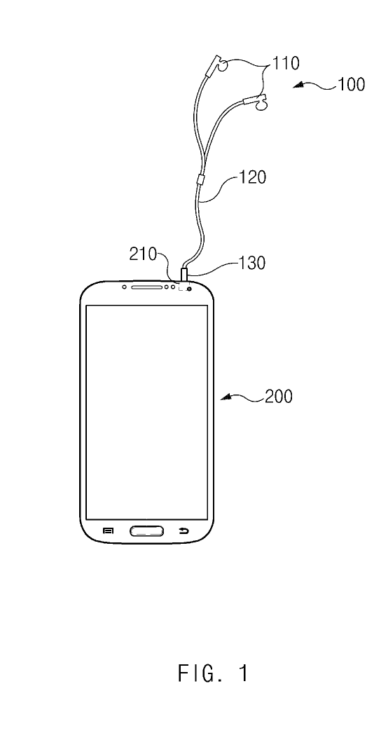

FIG. 1 is a diagram illustrating an example electronic device and an output device, according to an example embodiment.

Referring to FIG. 1, an output device (e.g., an external sound device) 100 may include a housing 110, a line 120, and a connector 130. The output device 100 may be, for example, and without limitation, a portable audio signal output device such as earphones or a headset. The output device 100 may be a device (hereinafter referred to as a “first type output device”) that may output a balanced audio signal.

The housing 110 may be configured to be inserted into ears of a user. The housing 110 may include at least one speaker therein. The housing 110 may be put in the ears of the user such that sound waves from the speaker within the housing are transferred to eardrums of the user. The housing 110 may include a first housing put in a left ear of the user and a second housing put in a right ear of the user. The housing 110 may, for example, be formed of a material such as plastic or rubber.

The line 120 may be connected to the housing 110. The line 120 may include a wire that electrically connects the speaker included in the housing 110 with the connector 130. The line 120 may include an insulator surrounding the wire. The line 120 may transfer an audio signal, which is transferred from the electronic device 200 to the connector 130, to the speaker included in the housing 110 through the wire.

The connector (e.g., an audio plug) 130 may be electrically connected with the line 120. The connector 130 may be electrically connected with an external sound device including a speaker through the line 120. The connector 130 may transfer an audio signal transferred from the electronic device 200 to the speaker through the line 120.

The electronic device 200 may include a receptacle (e.g., an audio jack) 210. The electronic device 200 may include a housing surrounding other components thereof. The housing may include an opening defined in one surface thereof. The receptacle 210 may be formed in a hole shape in the opening. The receptacle 210 of the electronic device 200 may be configured to receive the connector 130.

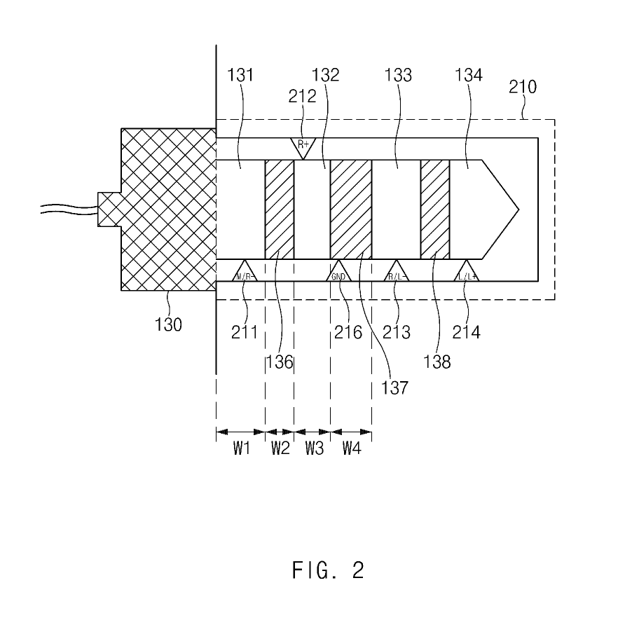

FIG. 2 is a diagram illustrating an example state in which an electronic device and an output device are matched, according to an example embodiment.

Referring to FIG. 2, the connector 130 may include a plurality of terminals (metal areas) and a plurality of insulating members (nonmetal areas). The connector 130 may include a member (e.g., a terminal and an insulating member) that extends in a lengthwise direction and includes a first end adjacent to the line 120 and a second end opposite to the first end. In this description, the lengthwise direction (or an axial direction) refers a direction from the first end to the second end.

According to an example embodiment, the connector 130 may include a first terminal 131, a first insulating member 136, a second terminal 132, a second insulating member 137, a third terminal 133, a third insulating member 138, and a fourth terminal 134 in order of the lengthwise direction.

The first terminal (or a first metal area) 131 may be situated at the first end of the connector 130. In the example where the connector 130 is matched with the receptacle 210 of the electronic device 200, the first terminal 131 may contact a first contact 211 of the receptacle 210. The first terminal 131 may receive an antiphase signal (hereinafter referred to as an “R− signal”) of a right channel signal, which is to be transferred to the right ear of the user, of a balanced audio signal from the first contact 211. According to an example embodiment, a width W1 of the first terminal 131 may be larger than a width W3 of the second terminal 132.

The first insulating member (or a first nonmetal area) 136 may be adjacent to the first terminal 131 in the lengthwise direction. The first insulating member 136 may be interposed between the first terminal 131 and the second terminal 132. The first insulating member 136 may electrically separate the first terminal 131 and the second terminal 132. A width W2 of the first insulating member 136 may be smaller than a width W4 of the second insulating member 137.

The second terminal (or a second metal area) 132 may be adjacent to the first insulating member 136 in the lengthwise direction. The second terminal 132 may contact a second contact 212 if the connector 130 is matched with the receptacle 210. The second terminal 132 may receive the right channel signal (hereinafter referred to as an “R+ signal”), which is to be transferred to the right ear of the user, of the balanced audio signal from the second contact 212.

According to an example embodiment, a width W3 of the second terminal 132 may be narrower than the width W1 of the first terminal 131. The second terminal 132 may have a width narrower than that of the first terminal 131 such that the second terminal 132 does not contact the ground contact 216 when the connector 130 is matched with the receptacle 210. In this description, the term “matching” may refer, for example, to a state in which the connector 130 is completely inserted into the receptacle 210 such that terminals of the connector 130 are connected to locations of the receptacle 210 that are in advance specified by a manufacturer thereof.

According to an example embodiment, the width W3 of the second terminal 132 may be substantially the same as a width W4 of the second insulating member 137.

The second insulating member (or a second nonmetal area) 137 may be adjacent to the second terminal 132 in the lengthwise direction. The second insulating member 137 may be interposed between the second terminal 132 and the third terminal 133. The second insulating member 137 may electrically separate the second terminal 132 and the third terminal 133. The second insulating member 137 may be arranged to contact a ground contact 216 when the connector 130 is matched with the receptacle 210.

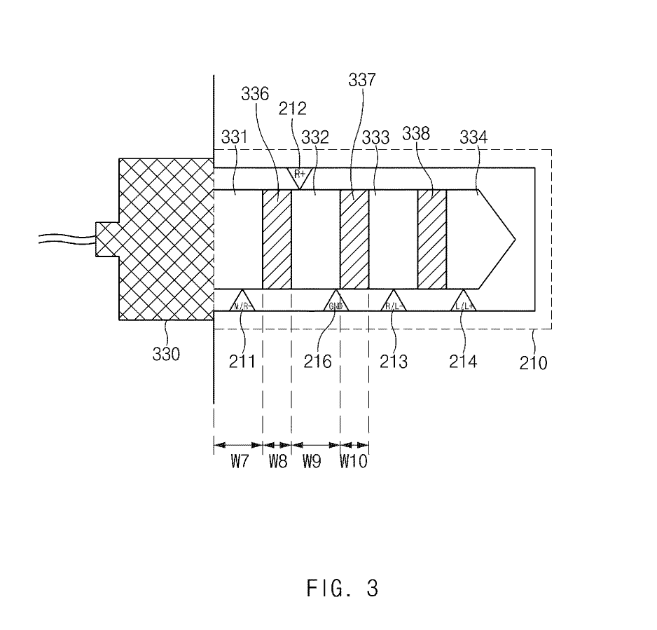

According to an example embodiment, a width W4 of the second insulating member 137 may be larger than the width W2 of the first insulating member 136. The second insulating member 137 may have a width, which is wider than that of the first insulating member 136, such that the second insulating member 137 contacts the ground contact 216 when the connector 130 is matched with the receptacle 210. According to an example embodiment, the width W4 of the second insulating member 137 may be substantially the same as the width W3 of the second terminal 132. The width W4 of the second insulating member 137 may be, for example, larger than a width W10 of a second insulating member 337 illustrated in FIG. 3.

The third terminal (or a third metal area) 133 may be adjacent to the second insulating member 137 in the lengthwise direction. The third terminal 133 may contact a third contact 213 if the connector 130 is matched with the receptacle 210. The third terminal 133 may receive an antiphase signal (hereinafter referred to as an “L-signal”) of a left channel signal, which is to be transferred to the left ear of the user, of the balanced audio signal from the third contact 213. Alternatively, the third terminal 133 may receive a right channel signal (hereinafter referred to as an “R signal”), which is to be transferred to the right ear of the user, of an unbalanced audio signal from the third contact 213.

The third insulating member (or a third nonmetal area) 138 may be adjacent to the third terminal 133 in the lengthwise direction. The third insulating member 138 may be interposed between the third terminal 133 and the fourth terminal 134. The third insulating member 138 may electrically separate the third terminal 133 and the fourth terminal 134.

The fourth terminal (or a fourth metal area) 134 may be adjacent to the third insulating member 138 in the lengthwise direction. The fourth terminal 134 may contact a fourth contact 214 if the connector 130 is matched with the receptacle 210. The fourth terminal 134 may receive the left channel signal (hereinafter referred to as an “L+ signal”), which is to be transferred to the left ear of the user, of the balanced audio signal from the fourth contact 214. Although not illustrated in FIG. 2, the fourth terminal 134 may include a groove that allows the connector 130 to be fixed in the receptacle 210.

The receptacle 210 may be configured to receive the connector 130. The receptacle 210 may receive the connector of the first type (e.g., the connector 130), which may receive the balanced audio signal. The receptacle 210 may be an audio jack that may receive a connector connected with a speaker. The receptacle 210 may be, for example, a 3.5π jack that may receive a plug of earphones or a headset.

The receptacle 210 may include a plurality of contacts (contact units). The receptacle 210 may include the first contact 211, the second contact 212, the third contact 213, the fourth contact 214, and the ground contact 216. Each of the first contact 211, the second contact 212, the third contact 213, the fourth contact 214, and the ground contact 216 may be formed of a conductive material.

The first contact 211 may be arranged to contact the first terminal 131 of the connector 130 when the connector 130 is matched with the receptacle 210. The first contact 211 may transfer the R− signal to the first terminal 131.

The second contact 212 may be arranged to contact the second terminal 132 when the connector 130 is matched with the receptacle 210. The second contact 212 may transfer the R+ signal to the second terminal 132.

The third contact 213 may be arranged to contact the third terminal 133 if the connector 130 is matched with the receptacle 210. The third contact 213 may transfer the L− signal to the third terminal 133.

The fourth contact 214 may be arranged to contact the fourth terminal 134 when the connector 130 is matched with the receptacle 210. The fourth contact 214 may transfer the L+ signal to the fourth terminal 134.

The ground contact 216 may be arranged to contact one of a plurality of insulating members of the connector 130 when the connector 130 is matched with the receptacle 210. For example, the ground contact 216 may be arranged to contact the second insulating member 137. The ground contact 216 may be electrically connected with a ground included in the electronic device 200. A switch may not be arranged between the ground contact 216 and the ground.

The ground contact 216 may be arranged to contact one of a plurality of insulating members of the connector of the first type (e.g., the connector 130 of FIG. 2) when the first type connector is received in (or inserted into) the receptacle 210. As another example, the ground contact 216 may be arranged to contact one of a plurality of insulating members of the connector of the second type (e.g., a connector 330 of FIG. 3) when the connector of the second type is received in (or inserted into) the receptacle 210. For example, even though a switch is not arranged between the ground contact 216 and the ground, the ground contact 216 may be arranged to contact an insulating member when the first type connector that does not need the connection with the ground is inserted into the receptacle 210 and to contact a terminal when the second type connector that needs the connection with the ground is inserted into the receptacle 210.

As the second insulating member 137 and the ground contact 216 are arranged to contact each other when the connector 130 that does not need the connection with the ground is inserted into the receptacle 210, it may be possible to prevent and/or avoid the following issues due to the switch arranged between the ground contact 216 and the ground: a reference signal for outputting an audio signal becomes unstable and the quality of the audio signal is degraded.

An example embodiment is illustrated in FIG. 2 as contacts are arranged in the lengthwise direction in the order of the first contact 211, the second contact 212, the ground contact 216, the third contact 213, and the fourth contact 214. However, embodiments are not limited thereto. For example, contacts may be arranged in a random order or may be arranged at locations different from locations illustrated in FIG. 2. Accordingly, signals transferred through the respective terminals may be different in type from those illustrated in FIG. 2.

FIG. 3 is a diagram illustrating an example state in which an electronic device and an output device (unbalanced) are matched, according to an example embodiment.

Referring to FIG. 3, the connector 330 (the second type connector) may include a first terminal 331, a second terminal 332, a third terminal 333, and a fourth terminal 334. The connector 330 may further include a first insulating member 336 interposed between the terminals 331 and 332, a second insulating member 337 interposed between the terminals 332 and 333, and a third insulating member 338 interposed between the terminals 333 and 334.

A width W7 of the first terminal 331 may be the same as a width W9 of the second terminal 332. Also, a width W8 of the first insulating member 336 may be the same as a width W10 of the second insulating member 337.

The second terminal 332 may contact the second contact 212 and the ground contact 216. As the second terminal 332 contacts the ground contact 216, the second terminal 332 may be grounded.

The receptacle 210 may be configured to receive the connector 330. The receptacle 210 may receive the second type connector (e.g., the connector 330) that may receive an unbalanced audio signal, for example.

The first contact 211 may contact the first terminal 331 when the connector 330 is matched with the receptacle 210. The first contact 211 may receive a microphone signal, which is generated by an output device, from the first terminal 331.

The third contact 213 may contact the third terminal 333 when the connector 330 is matched with the receptacle 210. Alternatively, the third contact 213 may transfer a right channel signal (hereinafter referred to as an “R signal”), which is to be transferred to the right ear of the user, of an unbalanced audio signal to the third terminal 333.

The fourth contact 214 may contact the third terminal 334 when the connector 330 is matched with the receptacle 210. The fourth contact 214 may transfer a left channel signal (hereinafter referred to as an “L signal”), which is to be transferred to the left ear of the user, of the unbalanced audio signal to the fourth terminal 334.

The ground contact 216 may contact one (e.g., the second terminal 332) of a plurality of terminals of the connector 330 when the connector 330 is matched with the receptacle 210. The second terminal 332 that contacts the ground contact 216 may be grounded.

As described above, the first terminal 331 of the connector 330 may transfer a microphone signal to the first contact 211 of the receptacle 210, the second terminal 332 may be grounded by the ground contact 216, the third terminal 333 may receive the R signal from the third contact 213, and the fourth terminal 334 may receive the L signal from the fourth contact 214.

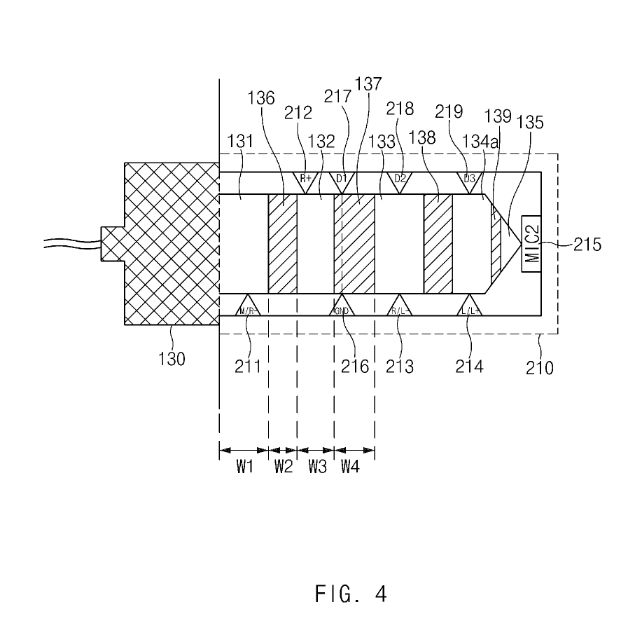

FIG. 4 is a diagram illustrating an example state in which an electronic device and an output device (balanced) are matched, according to an example embodiment.

Referring to FIG. 4, the connector 130 may include the first terminal 131, the first insulating member 136, the second terminal 132, the second insulating member 137, the third terminal 133, the third insulating member 138, a fourth terminal 134a, a fourth insulating member 139, and a fifth terminal 135.

The fourth terminal (or a fourth metal area) 134a may be adjacent to the third insulating member 138 in the lengthwise direction. The fourth terminal 134a may be configured to be different in shape from the fourth terminal 134 of FIG. 2. The fourth terminal 134a may be configured such that the third insulating member 138 is adjacent to one surface of the fourth terminal 134a and the fourth insulating member 139 is adjacent to an opposite surface thereof.

The fourth insulating member (or a fourth nonmetal area) 139 may be adjacent to the fourth terminal 134a in the lengthwise direction. The fourth insulating member 139 may be interposed between the fourth terminal 134a and the fifth terminal 135. The fourth insulating member 139 may electrically separate the fourth terminal 134a and the fifth terminal 135.

The fifth terminal (or a fifth metal area) 135 may be adjacent to the fourth insulating member 139 in the lengthwise direction. The fifth terminal 135 may contact a microphone contact 215 when the connector 130 is matched with the receptacle 210. The fifth terminal 135 may transfer a microphone signal, which is generated by a microphone of the output device 100, to the microphone contact 215.

The receptacle 210 may include the first contact 211, the second contact 212, the third contact 213, the fourth contact 214, the microphone contact 215, the ground contact 216, a first detecting contact 217, a second detecting contact 218, and a third detecting contact 219.

The first contact 211 may transfer an output signal to the first type connector. For example, in the example where the connector 130 is matched with the receptacle 210, the first contact 211 may transfer the R− signal to the first terminal 131. On the other hand, the first contact 211 may receive an input signal from the second type connector.

The microphone contact 215 may receive an input signal from the first type connector. For example, the microphone contact 215 may receive a microphone signal from the fifth terminal 135 when the connector 130 is matched with the receptacle 210.

The microphone contact 215 may contact the fifth terminal 135. Unlike the contacts 211 to 214 arranged on a side wall of the receptacle 210, the microphone contact 215 may be arranged on a front surface of the receptacle 210. Unlike the contacts 211 to 214 laterally being in contact with the connector 130, the microphone contact 215 may contact the connector 130 in the lengthwise direction of the connector 130.

The first detecting contact 217 may be arranged to measure impedance of a portion of the connector 130, which contacts the first detecting contact 217. According to an example embodiment, the first detecting contact 217 may be arranged to measure impedance of the second insulating member 137. For example, the first detecting contact 217 may be arranged at a location corresponding to a location of the ground contact 217 as illustrated in FIG. 3. Accordingly, the first detecting contact 217 may contact the insulating member, which the ground contact 216 contacts, when the ground contact 216 contacts the insulating member. Also, the first detecting contact 217 may contact a terminal, which the ground contact 216 contacts, when the ground contact 216 contacts the terminal. Since the ground contact 216 is connected with the ground, it is impossible to measure impedance of a portion of the connector 130, which contacts the ground contact 216. The electronic device 200 may measure impedance of a portion of the connector 130, which contacts the ground contact 216, through the first detecting contact 217 arranged at a location corresponding to a location of the ground contact 216. For example, the electronic device 200 may supply a signal for measuring impedance of a portion of the connector 130, which contacts the first detecting contact 217, through the first detecting contact 217 and may obtain a response signal to the supplied signal. In the example where the electronic device 200 supplies a uniform current (or voltage) through a detecting contact, the electronic device 200 may determine impedance based on a level of a voltage (or current) detected through the detecting contact.

The second detecting contact 218 may be arranged to measure impedance of a portion of the connector 130, which contacts the second detecting contact 218. For example, the second detecting contact 218 may be arranged to measure impedance of the third terminal 133. The electronic device 200 may measure impedance of the third terminal 133 through the second detecting contact 218.

The third detecting contact 219 may be arranged to measure impedance of a portion of the connector 130, which contacts the third detecting contact 219. For example, the third detecting contact 219 may be arranged to measure impedance of the fourth terminal 134a. The electronic device 200 may measure impedance of the fourth terminal 134a through the third detecting contact 219.

The first detecting contact 217, the second detecting contact 218, and the third detecting contact 219 illustrated in FIG. 4 may be also included in the receptacle 210 illustrated in FIGS. 2, 3, and 5 to 9.

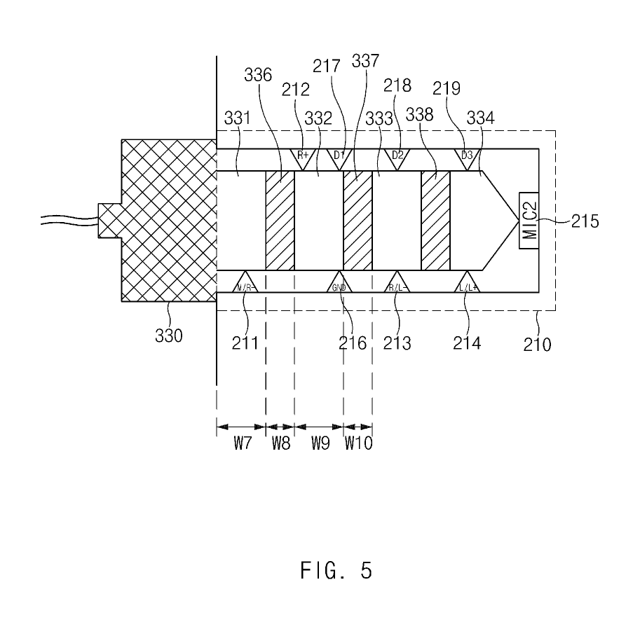

FIG. 5 is a diagram illustrating an example state in which an electronic device and an output device (unbalanced) are matched, according to an example embodiment.

Referring to FIG. 5, the receptacle 210 may be configured to receive the connector 330.

The first contact 211 may contact the first terminal 331 when the connector (second type connector) 330 is received in the receptacle 210. The first contact 211 may also receive a microphone signal from the first terminal 331.

The microphone contact 215 may contact a fourth terminal 334 when the connector 330 is received in the receptacle 210. The microphone contact 215 may not receive a signal from a fifth terminal.

The ground contact 216 may contact a second terminal 332 when the connector 330 is matched with the receptacle 210. The second terminal 332 that contacts the ground contact 216 may be grounded.

The first detecting contact 217 may contact the second terminal 332 when the connector 330 is received in the receptacle 210. The first detecting contact 217 may be arranged to measure impedance of the second terminal 332. As described above, the first terminal 331 of the connector 330 may transfer a microphone signal to the first contact 211 of the receptacle 210, the second terminal 332 may be grounded by the ground contact 216, the third terminal 333 may receive the R signal from the third contact 213, and the fourth terminal 334 may receive the L signal from the fourth contact 214. Also, the impedance of the second terminal 332 may be measured through the first detecting contact 217, the impedance of the third terminal 333 may be measured through the second detecting contact 218, and the impedance of the fourth terminal 334 may be measured through the third detecting contact 219.

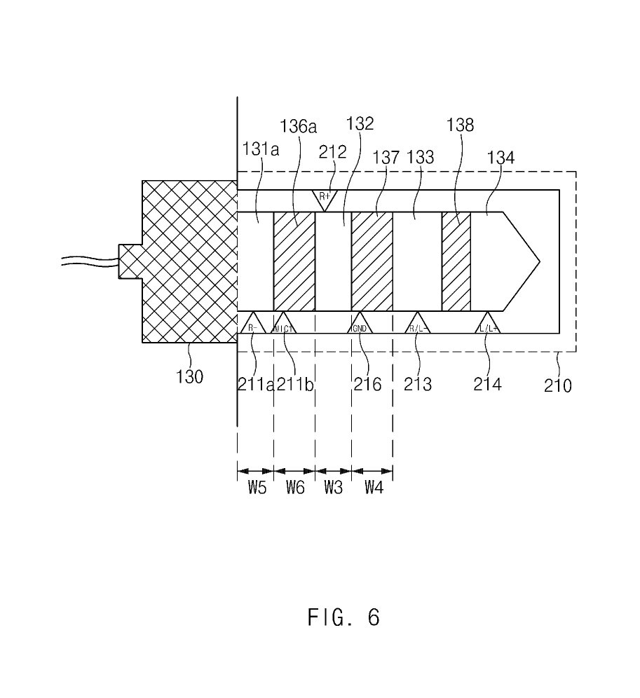

FIG. 6 is a diagram illustrating an example state in which an electronic device and an output device (balanced) are matched, according to an example embodiment.

Referring to FIG. 6, the connector 130 may include a first terminal 131a, a first insulating member 136a, the second terminal 132, the second insulating member 137, the third terminal 133, the third insulating member 138, and the fourth terminal 134.

The first terminal (first metal area) 131a may contact the first contact 211a when the connector 130 is matched with the receptacle 210. The first terminal 131a may receive the R− signal from the first contact 211a.

According to an embodiment, a width W5 of the first terminal 131a may be narrower than the width W1 of the first terminal 131 illustrated in FIG. 2. For example, the width W5 of the first terminal 131a may be substantially the same as the width W3 of the second terminal 132. The first terminal 131a may have a width, which is narrower than the width W1 of the first terminal 131, such that the first terminal 131a does not contact a microphone contact 211b when the connector 130 is matched with the receptacle 210.

The first insulating member (first nonmetal area) 136a may contact the microphone contact 211b when the connector 130 is matched with the receptacle 210.

According to an example embodiment, a width W6 of the first insulating member 136a may be narrower than the width W2 of the first insulating member 136 illustrated in FIG. 2. For example, the width W6 of the first insulating member 136a may be substantially the same as the width W4 of the second insulating member 137. As another example, the width W6 of the first insulating member 136a may be substantially the same as the width W5 of the first terminal 131a. The first insulating member 136a may have a width, which is wider than the width W2 of the first insulating member 136, such that the first insulating member 136a contacts the microphone contact 211b when the connector 130 is matched with the receptacle 210.

The receptacle 210 may include the first contact 211a, the microphone contact 211b, the second contact 212, the third contact 213, the fourth contact 214, and the ground contact 216.

The first contact 211a may be arranged to contact the first terminal 131a of the connector 130 when the connector 130 is matched with the receptacle 210. The first contact 211a may transfer the R− signal to the first terminal 131a.

The microphone contact 211b may be arranged to contact the first insulating member 136a of the connector 130 when the connector 130 is matched with the receptacle 210. The microphone contact 211b may be arranged to contact an insulating member when the first type connector is matched with the receptacle 210 and to contact a terminal when the second type connector is matched with the receptacle 210. The microphone contact 211b may receive an input signal (e.g., a microphone signal) from the second type connector.

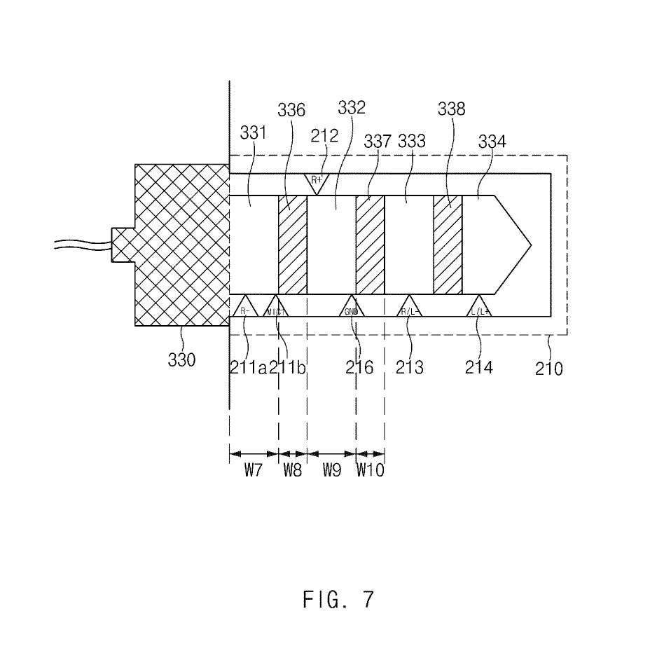

FIG. 7 is a diagram illustrating an example state in which an electronic device and an output device (unbalanced) are matched, according to an example embodiment.

Referring to FIG. 7, the receptacle 210 may be configured to receive the connector 330.

The microphone contact 211b may contact the first terminal 331 when the connector 330 is matched with the receptacle 210. The microphone contact 211b may receive a microphone signal from the first terminal 331.

The first terminal 331 of the connector 330 may transfer a microphone signal to the microphone contact 211b of the receptacle 210, the second terminal 332 may be grounded by the ground contact 216, the third terminal 333 may receive the R signal from the third contact 213, and the fourth terminal 334 may receive the L signal from the fourth contact 214.

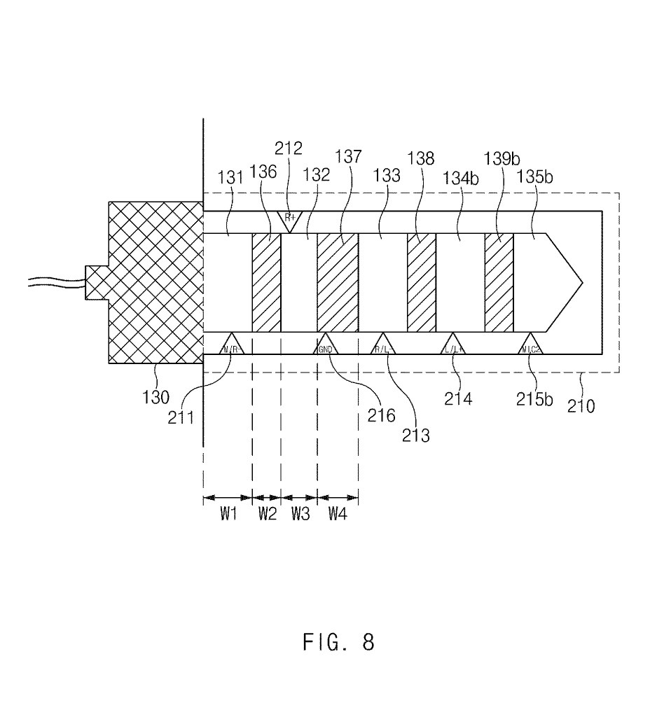

FIG. 8 is a diagram illustrating an example state in which an electronic device and an output device (balanced) are matched, according to an example embodiment.

Referring to FIG. 8, the connector 130 may include the first terminal 131, the first insulating member 136, the second terminal 132, the second insulating member 137, the third terminal 133, the third insulating member 138, a fourth terminal 134b, a fourth insulating member 139b, and a fifth terminal 135b.

The third insulating member 138 may be adjacent to one surface of the fourth terminal (fourth metal area) 134b and the fourth insulating member 139b may be adjacent to an opposite surface thereof. A shape of the fourth terminal 134b may be the same as that of the first terminal 131 or the third terminal 133. For example, the fourth terminal 134b may have the same width as the width W1 of the first terminal 131.

The fourth insulating member (fourth nonmetal area) 139b may be interposed between the fourth terminal 134b and the fifth terminal 135b. A shape of the fourth insulating member 139b may be the same as that of the first insulating member 136 or the third insulating member 138. For example, the fourth insulating member 139b may have the same width as the width W2 of the first insulating member 136.

The fifth terminal (fifth metal area) 135b may contact the microphone contact 215b when the connector 130 is matched with the receptacle 210. A shape of the fifth terminal 135b may be the same as that of the fourth terminal 214 of FIG. 2. The fifth terminal 135b may transfer a microphone signal, which is generated by a microphone of the output device 200, to the microphone contact 215b.

As illustrated in FIG. 8, a length of the connector 130 illustrated in FIG. 8 may be longer than a length of the connector 130 illustrated in FIGS. 2 to 7.

The receptacle 210 may include the first contact 211, the second contact 212, the third contact 213, the fourth contact 214, a microphone contact 215b, and the ground contact 216.

The microphone contact 215b may receive an input signal from the first type connector. For example, the microphone contact 215b may receive a microphone signal from the fifth terminal 135b when the connector 130 is matched with the receptacle 210.

The microphone contact 215b may contact the fifth terminal 135b. The microphone contact 215b may be arranged on a side wall of the receptacle 210 like the contacts 211 to 214. The microphone contact 215b may laterally contact the connector 130 with respect to the lengthwise direction of the connector 130 like the contacts 211 to 214.

As illustrated in FIG. 8, a length of the receptacle 210 illustrated in FIG. 8 may be longer than a length of the receptacle 210 illustrated in FIGS. 2 to 7.

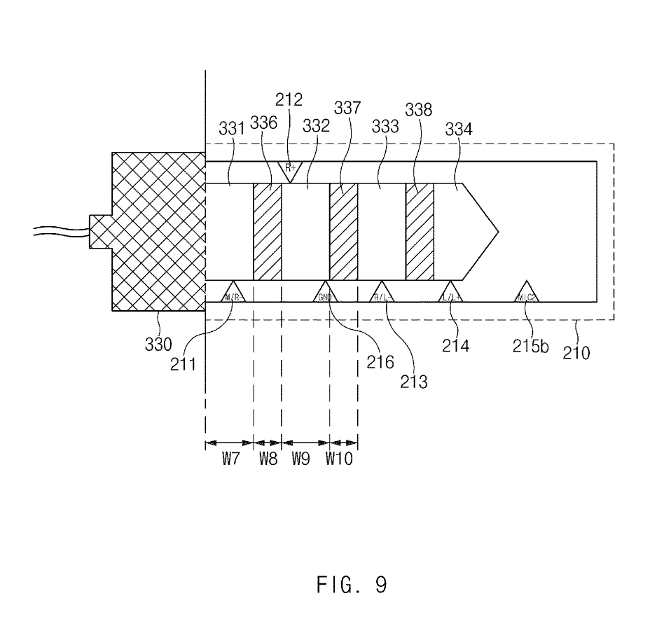

FIG. 9 is a diagram illustrating an example state in which an electronic device and an output device (unbalanced) are matched, according to an example embodiment.

Referring to FIG. 9, the receptacle 210 may be configured to receive the connector 330.

The microphone contact 215b may not contact the connector 330 when the connector 330 is matched with the receptacle 210.

The first terminal 331 of the connector 330 may transfer a microphone signal to the first contact 211 of the receptacle 210, the second terminal 332 may be grounded by the ground contact 216, the third terminal 333 may receive the R signal from the third contact 213, and the fourth terminal 334 may receive the L signal from the fourth contact 214.

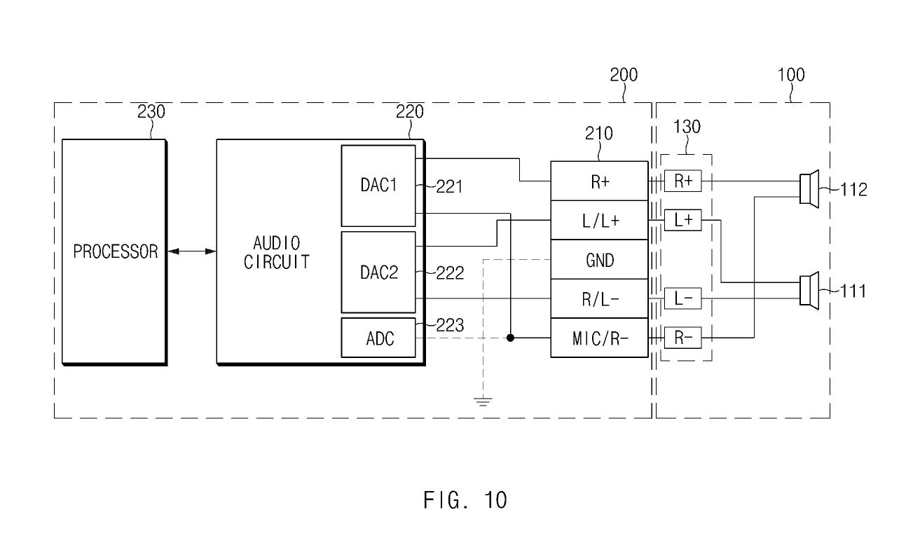

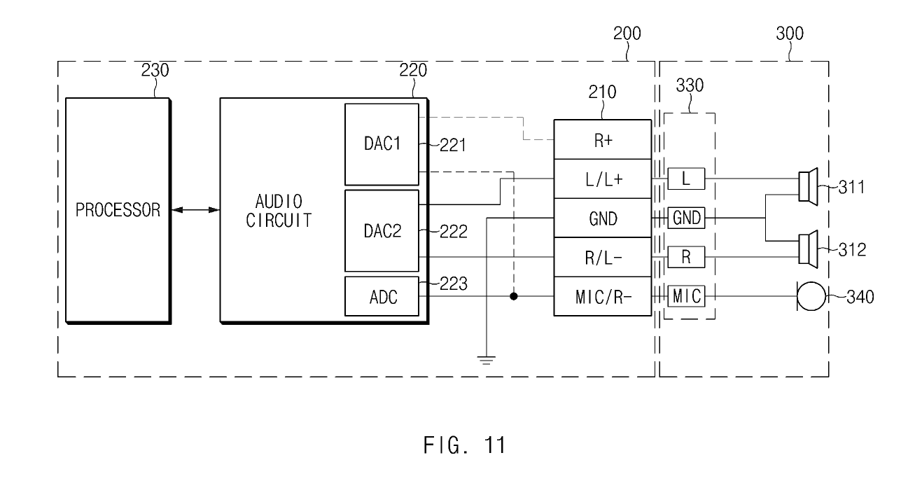

FIG. 10 is a block diagram illustrating an example configuration of an electronic device that is coupled with an output device outputting a balanced audio signal, according to an example embodiment. FIG. 11 is a block diagram illustrating an example configuration of an electronic device that is coupled with an output device outputting an unbalanced audio signal, according to an example embodiment. Components illustrated in FIGS. 10 and 11 may include components illustrated in FIGS. 2 and 3.

Referring to FIG. 10, the output device 100 may include a left speaker 111, a right speaker 112, and the connector 130. The output device 100 may be a device that outputs a balanced audio signal.

The left speaker 111 may receive and output the L+ signal and the L-signal from the electronic device 200 through the connector 130. The left speaker 111 may output a sound wave after differentially amplifying the L+ signal and the L− signal to remove noise. The left speaker 111 may be included in a housing of the output device 100.

The right speaker 112 may receive and output the R+ signal and the R− signal from the electronic device 200 through the connector 130. The right speaker 112 may output a sound wave after differentially amplifying the R+ signal and the R− signal to remove noise. The right speaker 112 may be included in the housing of the output device 100.

The connector 130 (e.g., including the first terminal 131, the second terminal 132, the third terminal 133, and the fourth terminal 134 of FIG. 1) may be inserted into the receptacle 210 of the electronic device 200 to receive an audio signal from a plurality of contacts of the receptacle 210. The connector 130 may receive the L+ signal, the L− signal, the R+ signal, and the R− signal from the plurality of contacts and may transfer the received signals to the left speaker 111 or the right speaker 112.

The electronic device 200 may include the receptacle 210, an audio circuit 220, and a processor 230. The electronic device 200 may be electrically connected with the output device 100 that may output a balanced audio signal.

The receptacle 210 may receive a connector (the first type connector) of the output device 100. The receptacle 210 may include a plurality of contacts (the first contact 211, the second contact 212, the third contact 213, the fourth contact 214, and the ground contact 216) that may contact a plurality of terminals (e.g., the first terminal 131, the second terminal 132, the third terminal 133, and the fourth terminal 134 illustrated in FIG. 2) or a plurality of insulating members (e.g., the first insulating member 136, the second insulating member 137, and the third insulating member 138) included in the connector. Blocks in the receptacle 210 of FIG. 10 indicate contacts included in the receptacle 210 and letters written in the blocks indicate types of signals that are provided to corresponding contacts or are received therefrom.

The audio circuit 220 may include a first digital-analog converter (DAC) 221 (hereinafter referred to as “DAC1”), a second digital-analog converter 222 (hereinafter referred to as “DAC2”), and an analog-digital converter 223 (hereinafter referred as “ADC”).

The audio circuit 220 may be electrically connected with a plurality of contacts and may send and receive a balanced audio signal to and from the output device 100.

The DAC1 221 may convert a digital signal from the processor 230 to an analog signal. The DAC1 221 may send an output signal, which is converted into the analog signal, to the output device 100.

In the example where the connector of the output device 100 is inserted into the receptacle 210, the DAC1 221 may provide an output signal to the right speaker 112 through a terminal connected with the DAC2 222 and any other terminal. For example, the DAC1 221 may provide the R+ signal and the R− signal to the right speaker 112.

The DAC1 221 may provide a portion of an output signal to the right speaker 112 through one terminal. For example, the DAC1 221 may provide the R+ signal to the right speaker 112 through one terminal and may provide the R− signal to the right speaker 112 through any other terminal.

The DAC1 221 may provide an output signal if an input signal is not received from one of the connector 130. For example, as illustrated in FIG. 10, in the example where the output device 100 does not include a microphone, an input signal may not be received from the connector 130. In this example, the DAC1 221 may provide output signals, such as the R+ signal and the R− signal, to the output device 100. For example, in the example where an input signal is not received through a contact MIC/R−, the DAC1 221 may provide the R− signal to the output device 100 through the contact MIC/R−.

The DAC2 222 may convert a digital signal from the processor 230 to an analog signal. The DAC2 221 may send an output signal, which is converted into the analog signal, to the output device 100.

In the example where the connector of the output device 100 is inserted into the receptacle 210, the DAC2 222 may provide an output signal to the left speaker 111 through a terminal connected with the DAC1 221 and any other terminal. For example, the DAC2 222 may provide the L+ signal and the L− signal to the left speaker 111. For example, the DAC2 222 may provide the L+ signal to the left speaker 111 through one terminal and may provide the L− signal to the left speaker 111 through any other terminal.

The ADC 223 may convert an analog signal from the output device 100 or the like to a digital signal. The ADC 223 may transfer an input signal converted into the digital signal to the processor 230. For example, the ADC 223 may receive an audio signal generated by a microphone of the output device 100. In the example where an input device such as a microphone or the like is not included in the output device 100, as illustrated in FIG. 10, the ADC 223 may not receive an audio signal.

The processor 230 will be described in greater detail below with reference to FIG. 11.

Referring to FIG. 11, an output device 300 may include a left speaker 311, a right speaker 312, and the connector 330, and a microphone 340. The output device 300 may be a device that may output an unbalanced audio signal.

The left speaker 311 may receive and output the L signal from the electronic device 200 through the connector 330. The left speaker 311 may output a sound wave by using the received L signal and a ground. The left speaker 311 may be included in a housing of the output device 300.

The right speaker 312 may receive and output the R signal from the electronic device 200 through the connector 330. The right speaker 312 may output a sound wave by using the received R signal and the ground. The right speaker 312 may be included in the housing of the output device 300.

The microphone 340 may detect a sound wave generated on the outside to generate an electrical signal. The microphone 340 may detect vibration by a sound wave to generate an input signal. The microphone 340 may be included in the housing of the output device 300. The input signal that is generated by the microphone 340 may be transferred to the electronic device 200 through the connector 330.

The microphone 340 is illustrated in FIG. 11 as being included in the output device 300. However, the microphone 340 may not be included in the output device 300 as a selective component.

The electronic device 200 may be electrically connected with the output device 300 that may output an unbalanced audio signal.

The audio circuit 220 may send and receive an unbalanced audio signal to and from the output device 300.

The DAC1 221 may not provide an output signal in the example where a connector (the second type connector) of the output device 300 is inserted into the receptacle 210. The DAC1 221 may not provide an output signal to the output device 300 that outputs an unbalanced audio signal.

In the example where the connector of the output device 300 is inserted into the receptacle 210, the DAC2 222 may provide output signals to the left speaker 111 and the right speaker 112 through one of the connector 330. For example, the DAC2 222 may provide the L signal and the R signal to the output device 330 that outputs an unbalanced audio signal.

The ADC 223 may receive an input signal through the connector 330 in the example where the connector of the output device 300 is inserted into the receptacle 210. For example, the ADC 223 may receive an input signal generated by the microphone 340. In particular, in the example where an input signal is received through the contact MIC/R−, the ACD 223 may receive the input signal through the contact MIC/R−. The ADC 223 may convert an input signal from the microphone 340 to a digital signal.

The processor 230 may be electrically connected with the audio circuit 220 and may control the audio circuit 220.

Referring to FIGS. 10 and 11, the processor 230 may determine a type of the output device 100 through some of contacts of the receptacle 210.

According to an example embodiment, the processor 230 may determine a type of an output device (or a connector of an output device) through a contact that is electrically connected with a ground. For example, the contact that is electrically connected with the ground may be the ground contact 216 illustrated in FIG. 2. For example, in the example where a contact that is electrically connected with a ground contacts an insulating member of a connector, the processor 230 may determine an output device to be an output device of a first type (e.g., the output device 100). As another example, in the example where a contact that is electrically connected with the ground contacts one of the connector 330, the processor 230 may determine an output device to be the second type output device (e.g., the output device 300).

According to an example embodiment, the processor 230 may determine a type of an output device based on impedance measured through a detecting contact. For example, the detecting contact may be the first detecting contact 217 illustrated in FIGS. 4 and 5. For example, in the example where a value of impedance measured through the detecting contact is infinite, e.g., in the example where the detecting contact contacts an insulating member of a connector, the processor 230 may determine an output device to be the first type output device (e.g., the output device 100). As another example, in the example where a value of impedance measured through the detecting contact is about 6 to 300 ohms, e.g., in the example where the detecting contact contacts one of the terminal 330, the processor 230 may determine an output device to be the second type output device (e.g., the output device 300).

According to an example embodiment, on the basis of a type of the output device, the processor 230 may control the audio circuit 220 such that an output signal is provided to at least some of a plurality of terminals of the output device.

For example, in the example where the detecting contact contacts an insulating member (e.g., in the example where the output device 100 is connected with the electronic device 200), the processor 230 may send a balanced audio signal to the output device 100. The processor 230 may control the audio circuit 220 such that the DAC1 221 provides the R+ signal and the R− signal to the output device 100 and the DAC2 222 provides the L+ signal and the L− signal thereto.

As another example, in the example where the detecting contact contacts a terminal (e.g., in the example where the output device 300 is connected with the electronic device 200), the processor 230 may send an unbalanced audio signal to the output device 300. The processor 230 may control the audio circuit 220 such that the DAC1 221 does not provide a signal to the output device 300 and the DAC2 222 provides the L signal and the R signal thereto. Also, the processor 230 may control the audio circuit 220 to allow the ADC 223 to receive an input signal from the microphone 340.

The operations that are described as being performed by the processor 230 may be performed by the audio circuit 220.

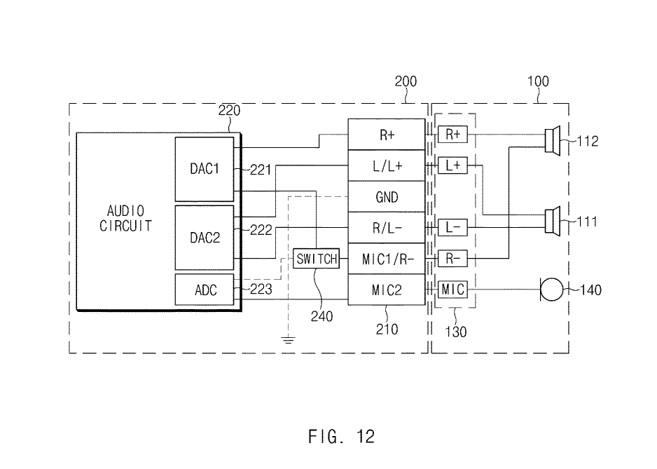

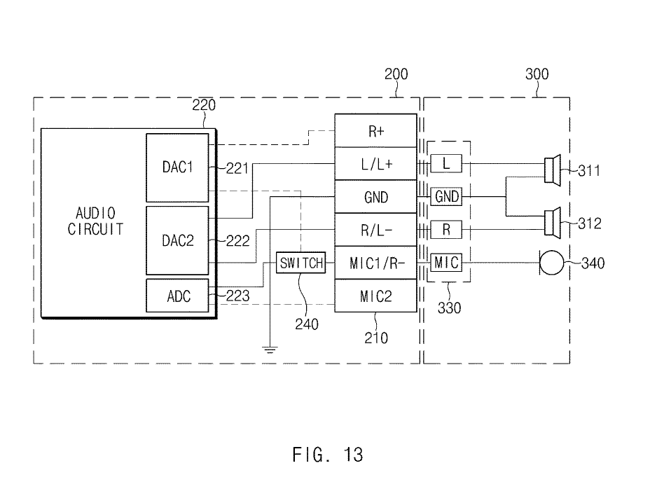

FIG. 12 is a block diagram illustrating an example configuration of an electronic device that is coupled with an output device outputting a balanced audio signal, according to an example embodiment. FIG. 13 is a block diagram illustrating an example configuration of an electronic device that is coupled with an output device outputting an unbalanced audio signal, according to an example embodiment. Components illustrated in FIGS. 12 and 13 may include components illustrated in FIGS. 4 and 5.

Referring to FIG. 12, the output device 100 may include the left speaker 111, the right speaker 112, the connector 130, and a microphone 140. The output device e 100 may be the first type output device.

The connector 130 may further include a microphone terminal MIC that is electrically connected with the microphone 140. The microphone terminal MIC may transfer an input signal received from the microphone 140 to the electronic device 200.

The microphone 140 may generate an input signal using vibration by a sound wave. The input signal that is generated by the microphone 140 may be transferred to the microphone contact MIC2 through the microphone terminal MIC.

The electronic device 200 may include the receptacle 210, the audio circuit 220, and a switch 240.

The switch 240 may selectively connect a digital-analog converter or an analog-digital converter to one of a plurality of contacts. For example, the switch 240 may selectively connect the DAC1 221 or the ADC 223 to the contact MIC1/R−. In the example where the first type output device is connected with the electronic device 200, the switch 240 may connect the digital-analog converter with one of the plurality of contacts. For example, the switch 240 may electrically connect the DAC1 200 with the contact MIC1/R− when the electronic device 200 and the output device 100 are connected to each other. The switch 240 may be controlled by the audio circuit 220 or by the processor 230 illustrated in FIGS. 10 and 11.

The receptacle 210 may further include a microphone contact MIC2. The microphone contact MIC2 may be electrically connected with the ADC 223. The microphone contact MIC2 may transfer an input signal generated by the microphone 140 to the ADC 223. The microphone contact MIC2 may correspond to the microphone contact 215 illustrated in FIGS. 4 and 5 or the microphone 215b illustrated in FIGS. 8 and 9.

In the example where the electronic device 200 and the output device 100 are connected to each other, the DAC1 221 may provide output signals, such as the R+ signal and the R− signal, to the output device 100. A terminal that sends the R− signal of the DAC1 221 may be electrically connected with the switch 240. The R− signal may be provided to the output device 100 through the switch 240.

In the example where the electronic device 200 and the output device 100 are connected to each other, the ADC 223 may receive an input signal from the microphone 140 through the microphone contact MIC2 of the receptacle 210. The ADC 223 may convert the input signal received through the microphone contact MIC2 to a digital signal.

Referring to FIG. 13, the output device 300 may include the left speaker 311, the right speaker 312, the connector 330, and the microphone 340. The output device 300 may be the second type output device.

In the example where the second type output device is connected with the electronic device 200, the switch 240 may connect the analog-digital converter with one of the plurality of contacts. For example, in the example where the electronic device 200 and the output device 300 are connected to each other, the switch 240 may electrically connect the ADC 223 with the contact MIC1/R−.

The connection between the terminal MIC1/R− and the DAC1 221 or the ADC 223 by the switch 240 may become clear. Also, since the switch 240 is not connected with the ground, the quality of an unbalance audio signal may not degrade due to the switch 240.

In the example where the electronic device 200 and the output device 300 are connected to each other, the DAC1 221 may not provide an output signal to the output device 300. The DAC1 221 may be electrically separated from the contact MIC1/R− by the switch 240.

In the example where the electronic device 200 and the output device 300 are connected to each other, the ADC 223 may receive an input signal from the microphone 340 through the contact MIC1/R−. The ADC 223 may be electrically connected with the contact MIC1/R− by the switch 240. The ADC 223 may convert an input signal received through the contact MIC1/R− to a digital signal.

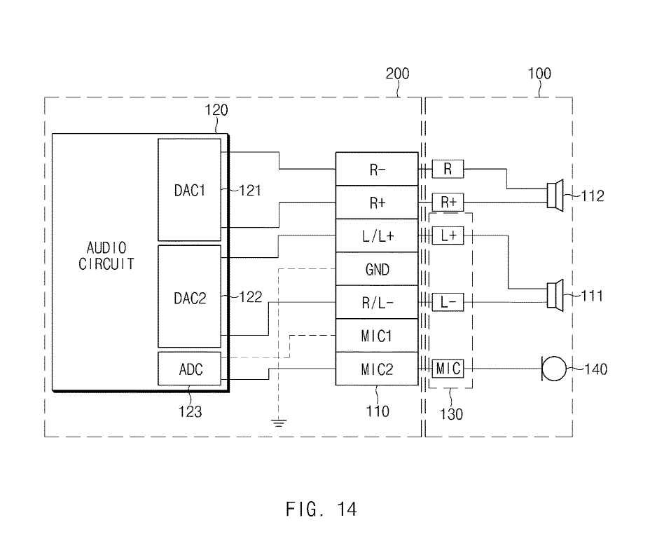

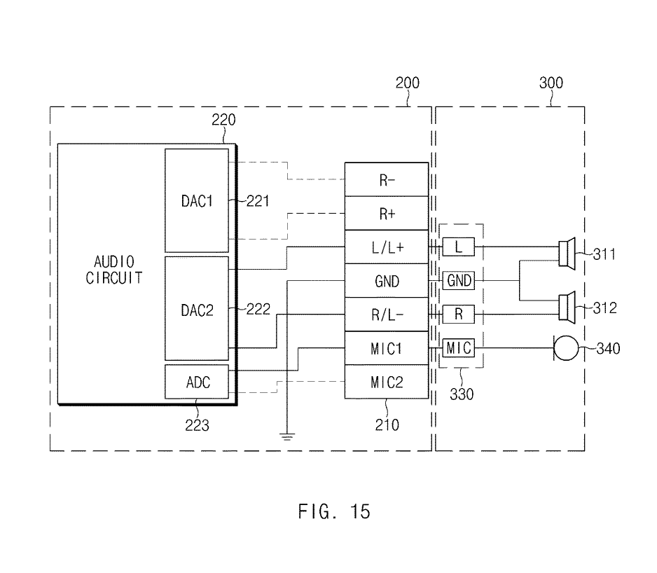

FIG. 14 is a block diagram illustrating an example configuration of an electronic device that is coupled with an output device outputting a balanced audio signal, according to an example embodiment. FIG. 15 is a block diagram illustrating an example configuration of an electronic device that is coupled with an output device outputting an unbalanced audio signal, according to an example embodiment. Components illustrated in FIGS. 14 and 15 may include components illustrated in FIGS. 6 and 7.

Referring to FIG. 14, the output device 100 may include the left speaker 111, the right speaker 112, the connector 130, and the microphone 140. The output device 100 may be the first type output device.

The electronic device 200 may include the receptacle 210 and the audio circuit 220.

The receptacle 210 may further include a contact R− and a contact MIC1. The contact R− may be electrically connected with the DAC 221, and the contact MIC1 may be electrically connected with the ADC 223. For example, the contact R− may correspond to the first contact 211a illustrated in FIG. 3, and the contact MIC1 may correspond to the microphone contact 211b illustrated in FIG. 3. As the contact R− and the contact MIC1 are separated from each other, a path for transferring an output signal and a path for transferring an input signal may be separated from each other without a switch.

The DAC1 221 may be electrically connected with the contact R−. In the example where the electronic device 200 and the output device 100 are connected to each other, the DAC1 221 may provide the R− signal through the contact R−.

In the example where the electronic device 200 and the output device 100 are connected to each other, the ADC 223 may receive an input signal from the microphone 140 through the contact MIC2. The ADC 223 may convert the input signal received through the contact MIC2 to a digital signal.

Referring to FIG. 15, the output device 300 may include the left speaker 311, the right speaker 312, the connector 330, and the microphone 340. The output device 300 may be the second type output device.

In the example where the electronic device 200 and the output device 300 are connected to each other, the contact MIC1 may transfer an input signal generated by the microphone 340 to the ADC 223.

In the example where the electronic device 200 and the output device 300 are connected to each other, the DAC1 221 may not provide an output signal to the output device 300. The DAC1 221 may not provide an output signal to the contact R−.

In the example where the electronic device 200 and the output device 300 are connected to each other, the ADC 223 may receive an input signal from the microphone 340 through the contact MIC1. The ADC 223 may convert the input signal received through the contact MIC1 to a digital signal.

According to an example embodiment of the present disclosure, an electronic device may include a housing, an opening defined in one surface of the housing, a hole communicating with the opening, a receptacle that is arranged in the interior of the hole and is configured to receive any one of a first external connector or a second external connector, and a circuit that is electrically connected with the receptacle, wherein the first external connector includes at least two terminals and a non-conductive member that is arranged between two terminals of the at least two terminals, the non-conductive member of the first external connector having a first width, wherein the second external connector includes at least two or more terminals and a non-conductive member that is arranged between two terminals of the at least two or more terminals, the non-conductive member of the second external connector having a second width wider than the first width, wherein the receptacle includes a first contact configured to contact one of the terminals of the first external connector if the first external connector is inserted therein and to contact the non-conductive member of the second external connector if the second external connector is inserted therein, and wherein the first contact is electrically connected with a ground.

According to another example aspect of the present disclosure, the first connector may be connected by wire with an external sound device that includes a first speaker and a second speaker, and if the first external connector is inserted into the receptacle, the circuit may be configured to provide an audio output to the first speaker and the second speaker through two terminals of the terminals of the first external connector.

According to another example aspect of the present disclosure, if the first external connector is inserted in the receptacle, the circuit may be configured to receive an audio signal from the external sound device through another terminal of the terminals of the first external connector.

According to another example aspect of the present disclosure, the second connector may be connected by wire with an external sound device that includes a first speaker and a second speaker, and if the second external connector is inserted into the receptacle, the circuit may be configured to provide a first audio output to the first speaker through two terminals of the terminals of the second external connector and to provide a second audio output to the second speaker through another two terminals of the terminals of the second external connector.

According to another example aspect of the present disclosure, a portion of the second audio output may be provided to the second speaker through one terminal which is adjacent to the non-conductive member of the second external connector, from among the terminals.

According to another example embodiment of the present disclosure, an electronic device may include an audio jack that receives an audio plug including a plurality of terminals and a plurality of insulating members arranged among the plurality of terminals and that includes a plurality of contacts that are capable of contacting the plurality of terminals or the plurality of insulating members, a circuit that is electrically connected with the plurality of contacts to send an audio signal to the audio plug, and a processor configured to control the circuit, wherein at least one of the plurality of contacts is electrically connected with a ground and is arranged to contact one of the plurality of insulating members of the audio plug if the audio plug is matched with the audio jack.

According to another example aspect of the present disclosure, the circuit or the processor may be configured to determine a type of the audio plug through some of the plurality of contacts and to send an output signal to at least some of the plurality of terminals of the audio plug based on the type of the audio plug.

According to another example aspect of the present disclosure, the circuit or the processor may be configured to determine the type of the audio plug through a contact which is electrically connected with the ground, from among the plurality of contacts.

According to another example aspect of the present disclosure, the circuit or the processor may be configured to determine the audio plug to be a plug of a first type if the contact electrically connected with the ground contacts the insulating member and to determine the audio plug to be a plug of a second type if the contact electrically connected with the ground contacts the terminal.

According to another example aspect of the present disclosure, the circuit or the processor may be configured to send an unbalanced audio signal to the audio plug if the contact electrically connected with the ground contacts the terminal and to send a balanced audio signal to the audio plug if the contact electrically connected with the ground contacts the insulating member.

According to another example aspect of the present disclosure, the audio jack may include one or more detecting contacts for measuring impedance of at least some of the plurality of terminals or the plurality of insulating members, and the circuit or the processor may be configured to determine the type of the audio plug based on the impedance measured through the detecting contact.

According to another example aspect of the present disclosure, the circuit may include a digital-analog converter configured to send an output signal to the audio plug and an analog-digital converter configured to receive an input signal from the audio plug.

According to another example aspect of the present disclosure, the circuit may receive the input signal through the analog-digital converter if the input signal is received from one of the plurality of terminals and may send the output signal through the digital-analog converter if the input signal is not received from one of the plurality of terminals.

According to another example aspect of the present disclosure, the circuit may further include a switch that selectively connects the digital-analog converter or the analog-digital converter with one of the plurality of contacts.

According to another example aspect of the present disclosure, the audio jack may include a first contact that receives the input signal from an audio plug capable of receiving an unbalanced audio signal and a second contact that receives the input signal from an audio plug capable of receiving a balanced audio signal and the circuit may receive the input signal from the first contact or the second contact through the analog-digital converter.

According to another example aspect of the present disclosure, the audio jack may be a 3.5π jack that receives an earphone plug.

According to another example aspect of the present disclosure, the audio jack may receive one of a first type plug capable of receiving a balanced audio signal or a second type plug capable of receiving an unbalanced audio signal, and at least one of the plurality of contacts may be arranged to contact one of a plurality of insulating members of the first type plug if the first type plug is received in the audio jack and to contact one of a plurality of terminals of the second type plug if the second type plug is received in the audio jack.

According to another example embodiment of the present disclosure, an audio output device may include a housing that includes at least one speaker and is configured to be put in ears of a user, a line that is connected to the housing and includes a wire, and a plug that is electrically connected to the line, wherein the plug includes a member that extends in a lengthwise direction and includes a first end adjacent to the line and a second end opposite to the first end, wherein the member includes a first metal area, a first nonmetal area, a second metal area, a second nonmetal area, a third metal area, a third nonmetal area, and a fourth metal area in order in a direction from the first end to the second end, and wherein a width of the first metal area is larger than a width of the second metal area.

According to another example aspect of the present disclosure, a width of the first nonmetal area may be smaller than a width of the second nonmetal area.

According to another example aspect of the present disclosure, a width of the second metal area may be substantially the same as a width of the second nonmetal area.

According to another example embodiment of the present disclosure, the electronic device may include an audio jack that receives a first type audio plug capable of receiving a balanced audio signal or a second type audio plug capable of receiving an unbalanced audio signal and that includes a plurality of contacts capable of contacting a plurality of terminals or a plurality of insulating members included in the first type audio plug or the second type audio plug, a circuit that is electrically connected with the plurality of contacts to send the balanced audio signal or the unbalanced audio signal to an audio plug matched with the audio jack, and a processor configured to control the circuit, wherein the plurality of contacts include a ground contact unit electrically connected with a ground, wherein the ground contact contacts one of a plurality of insulating members included in the first type audio plug if the first type audio plug is matched with the audio jack and contacts one of a plurality of terminals included in the second type audio plug if the second type audio plug is matched with the audio jack, and wherein the circuit is configured to provide the balanced audio signal to the first type audio plug if the ground contact contacts one of the plurality of insulating members and to provide the unbalanced audio signal to the second type audio plug if the ground contact contacts one of the plurality of terminals.

According to another example aspect of the present disclosure, the circuit may be configured to send an output signal to one of the plurality of terminals if an input signal is received from one of the plurality of terminals or if the input signal is not received from one of the plurality of terminals.

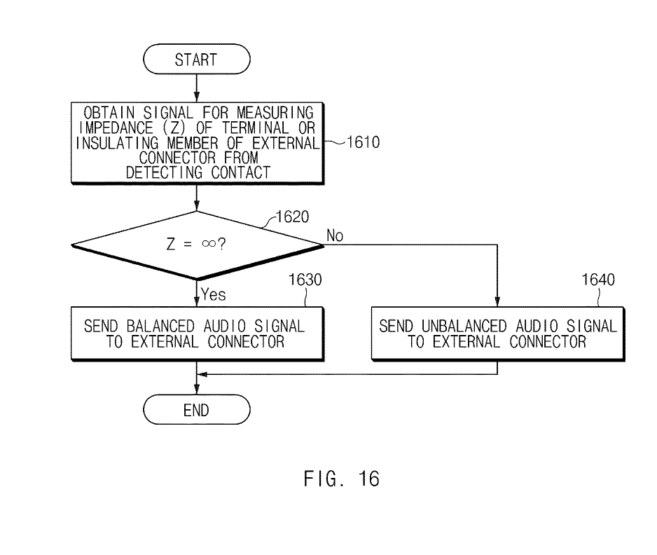

FIG. 16 is a flowchart illustrating an example audio signal output method of an electronic device according to various example embodiments of the present disclosure.

The flowchart illustrated in FIG. 16 may include operations that the electronic device 200 illustrated in FIGS. 6 to 11 processes. Accordingly, although omitted below, contents of the electronic device 200 described with reference to FIGS. 10 to 15 may be applied to the flowchart shown in FIG. 16.

Referring to FIG. 16, in operation 1610, the electronic device 200 may obtain a signal for measuring impedance of a terminal or an insulating member of an external connector from a detecting contact. The electronic device 200 may receive the external connector. The electronic device 200 may recognize whether the external connector is received therein. If a specific contact (e.g., the second detecting contact 218 or the third detecting contact 219) contacts a terminal of the external connector, the electronic device 200 may recognize that the external connector is received therein. If it is recognized that the external connector is received, the electronic device 200 may supply a signal for measuring impedance of a portion of the external connector, which contacts a detecting contact (e.g., the first detecting contact 217), through the detecting contact. The electronic device 200 may obtain a response signal to the signal supplied through the detecting contact. For example, in the example where the detecting contact is in contact with a terminal, the electronic device 200 may obtain a signal from the terminal. As another example, in the example where the detecting contact is in contact with an insulating member, the electronic device 200 may obtain a signal from the insulating member.

In operation 1620, the electronic device 200 may determine whether a value of the measured impedance is infinite.

The electronic device 200 may determine impedance of a portion of the external connector, which contacts the detecting contact, using the signal obtained in operation 1610. For example, in the example where the electronic device 200 supplies a uniform current through the detecting contact, the electronic device 200 may determine impedance based on a level of a voltage obtained by the detecting contact.

The electronic device 200 may determine whether a value of the measured impedance is infinite. According to an example embodiment, the electronic device 200 may determine whether a portion of the external connector, which the detecting contact contacts, corresponds to a terminal or an insulating member, based on the calculated impedance value. For example, if the determined impedance value is infinite, the electronic device 200 may determine that the portion of the external connector, which the detecting contact contacts, correspond to an insulating member. As another example, if the determined impedance value is about 6 to 300 ohms, the electronic device 200 may determine that the portion of the external connector, which the detecting contact contacts, correspond to a terminal.

If the detecting contact is in contact with the insulating member, in operation 1630, the electronic device 200 may send a balanced audio signal to the external connector. In the example where the detecting contact is in contact with the insulating member, an output device connected with the electronic device 200 may be a device (e.g., the output device 100) that may output a balanced audio signal. Accordingly, the electronic device 200 may send the balanced audio signal to the output device.

If the detecting contact is in contact with the terminal, in operation 1640, the electronic device 200 may send an unbalanced audio signal to the external connector. In the example where the detecting contact is in contact with the terminal, an output device connected with the electronic device 200 may be a device (e.g., the output device 300) that may output an unbalanced audio signal. Accordingly, the electronic device 200 may send the unbalanced audio signal to the output device.

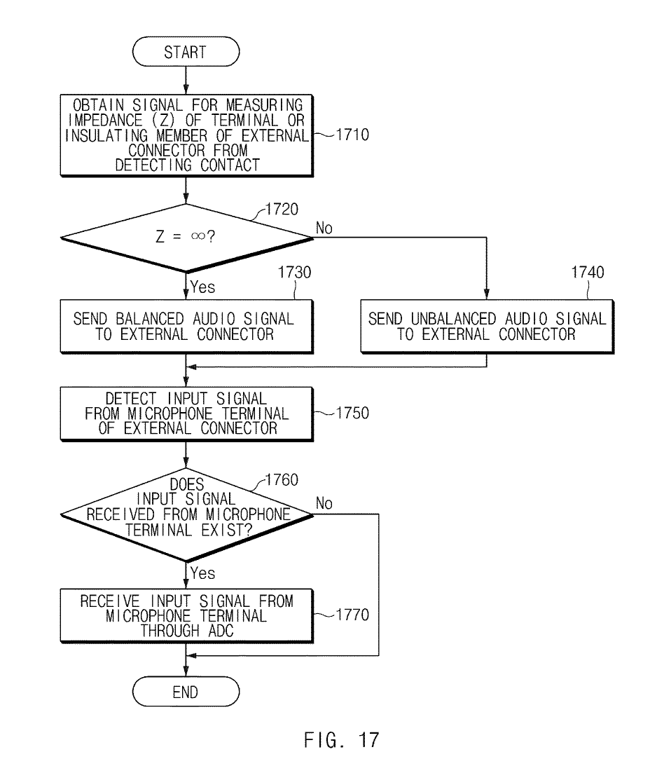

FIG. 17 is a flowchart illustrating an example audio signal output method of an electronic device according to various example embodiments of the present disclosure. For convenience of description, a description of operations that are the same as those described with reference to FIG. 12 will not be repeated here.

The flowchart illustrated in FIG. 17 may include operations that the electronic device 200 illustrated in FIGS. 10 to 15 processes. Accordingly, although omitted below, contents of the electronic device 200 described with reference to FIGS. 10 to 15 may be applied to the flowchart illustrated in FIG. 17.

Referring to FIG. 17, in operation 1710, the electronic device 200 may obtain a signal for measuring impedance of a terminal or an insulating member of an external connector from a detecting contact.

In operation 1720, the electronic device 200 may determine whether a value of the measured impedance is infinite.

If the detecting contact is in contact with the insulating member, in operation 1730, the electronic device 200 may send a balanced audio signal to the external connector.

If the detecting contact is in contact with the terminal, in operation 1740, the electronic device 200 may send an unbalanced audio signal to the external connector.

In operation 1750, the electronic device 200 may detect input signal from microphone terminal of external connector. For example, the electronic device 200 may detect a voltage applied to a contact of the receptacle 210 connected with the microphone terminal.

In operation 1760, the electronic device 200 may determine whether an input signal received from a microphone terminal of an output device exists. For example, in the example where a voltage of about 2 to 2.4 V is applied to the contact connected with the microphone contact, the electronic device 200 may determine that an input signal received from the microphone of the output device exists. As another example, in the example where a voltage is not applied to the contact connected with the microphone contact (e.g., in the example where a voltage is 0 V), the electronic device 200 may determine that an input signal received from the microphone of the output device does not exist.

If the input signal exists, in operation 1770, the electronic device 200 may receive the input signal from the microphone terminal through the ADC 223. After operating the ADC 223, the electronic device 200 may receive the input signal and may convert the input signal into a digital signal.

If the input signal does not exist, the electronic device may not operate the ADC 223. In this example, the electronic device 200 may provide an output signal to a contact, which is in contact with the microphone terminal, through the DAC1 221.

According to an example embodiment of the present disclosure, an audio signal output method of an electronic device may include: obtaining a signal for measuring impedance of a terminal or an insulating member of an external connector, determining whether a value of the impedance is included in a specific range, based on the signal, and sending a balanced audio signal to the external connector if the value of the impedance is included in the specific range and sending an unbalanced audio signal to the external connector if the value of the impedance is not included in the specific range.

According to another example aspect of the present disclosure, the method may further include detecting an input signal from a microphone terminal of the external connector, and receiving the input signal through an analog-digital converter if the input signal is detected.

According to another example aspect of the present disclosure, the determining may include determining the external connector to be a connector for the balanced audio signal if the value of the impedance is included in the specific range and determining the external connector to be a connector for the unbalanced audio signal if the value of the impedance is not included in the specific range.

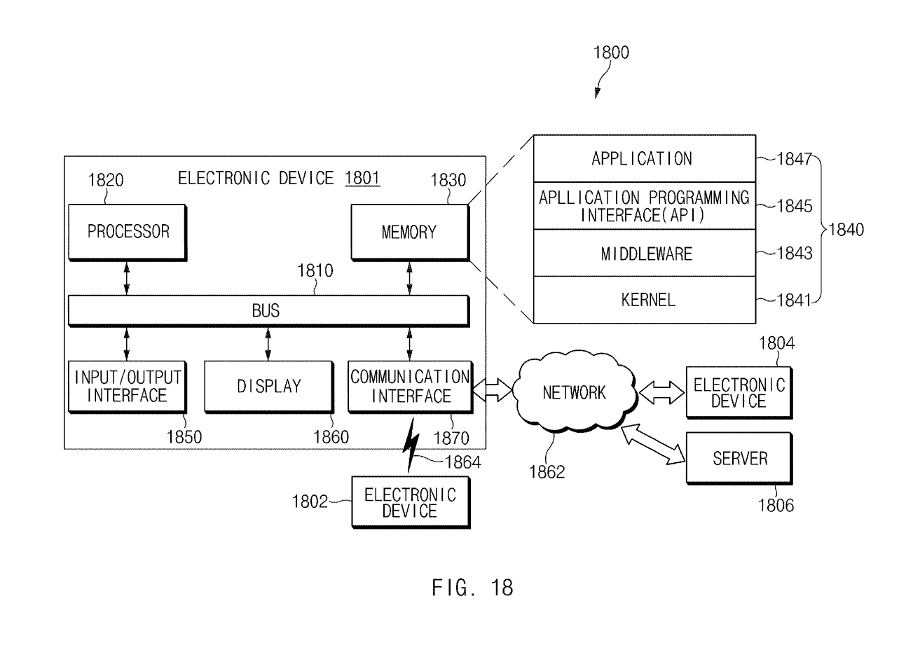

FIG. 18 is a diagram illustrating an example electronic device in a network environment 1800 according to various example embodiments;

Referring to FIG. 18, the electronic device 1801, 1802, 1804 or the server 1806 according to various example embodiments may be connected to each other through a network 1862 or a short range communication 1864. The electronic device 1801 may include a bus 1810, a processor 1820, a memory 1830, an input/output interface (e.g., including input/output interface circuitry) 1850, a display 1860, and a communication interface (e.g., including communication circuitry) 1870. In some example embodiments, the electronic device 1801 may exclude at least one of the elements or may additionally include another element.

The bus 1810, for example, may include a circuit that connects the elements 1810 to 1870 and transfers communications (for example, control messages and/or data) between the elements.

The processor 1820 may include one or more of a central processing unit (CPU), an application processor (AP), or a communication processor (CP). The processor 1820, for example, may execute operations or data processing related to the control and/or communication of at least one other element of the electronic device 1801.

The memory 1830 may include a volatile and/or nonvolatile memory. The memory 1830, for example, may store commands or data related to at least one other element of the electronic device 1801. According to an embodiment, the memory 1830 may store software and/or a program 1840. The program 1840, for example, may include a kernel 1841, middleware 1843, an application programming interface (API) 1845, and/or an application program (or an application) 1847. At least some of the kernel 1841, the middleware 1843, or the API 1845 may be referred to as an operating system (OS).

The kernel 1841, for example, may control or manage system resources (for example, the bus 1810, the processor 1820, and the memory 1830) that are used to execute operations or functions implemented in the other programs (for example, the middleware 1843, the API 1845, or the applications 1847). The kernel 1841 may provide an interface through which the middleware 1843, the API 1845, or the applications 1847 access individual elements of the electronic device 1801 to control or manage the system resources.

The middleware 1843, for example, may function as an intermediary that allows the API 1845 or the applications 1847 to communicate with the kernel 1841 to exchange data.

The middleware 1843 may process one or more work requests received from the application programs 1847, according to their priorities. For example, the middleware 1843 may give a priority, by which a system resource (for example, the bus 1810, the processor 1820, or the memory 1830) of the electronic device 1801 may be used, to at least one of the application programs 1847. For example, the middleware 1843 may perform scheduling or load balancing for the one or more work requests by processing the one or more work requests according to the priority given to the at least one of the application programs 1847.

The API 1845 is an interface used, by the application 1847, to control a function provided by the kernel 1841 or the middleware 1843, and may include, for example, at least one interface or function (for example, an instruction), for example, for file control, window control, image processing, and text control.

The input/output interface 1850, for example, may include various input/output interface circuitry configured to function as an interface that may transfer commands or data that are input from the user or another external device to another element(s) of the electronic device 1801. The input/output interface 1850 may output commands or data received from another element(s) of the electronic device to the user or anther external device 1801.

The display 1860, for example, may include a liquid crystal display (LCD), a light emitting diode (LED) display, an organic light emitting diode (OLED) display, a microelectromechanical system (MEMS) display, or an electronic paper display, or the like, but is not limited thereto. The display 1860, for example, may display various contents (for example, a text, an image, a video, an icon, and a symbol). The display 1860 may include a touch screen and receive, for example, a touch, a gesture, a proximity, or a hovering input using an electronic pen or the user's body.

The communication interface 1870, for example, may include various communication circuitry configured to set communication between the electronic device 1801 and an external device (for example, a first external electronic device 1802, a second external electronic device 1804, or a server 1806). For example, the communication interface 1870 may be connected to a network 1862 through a wireless communication or a wired communication to communicate with the external device (for example, the second external electronic device 1804 or the server 1806).

The wireless communication is, for example, a cellular communication protocol, and, for example, may use at least one of long-term evolution (LTE), LTE-advanced (ATE-A), code division multiple access (CDMA), wideband CDMA (WCDMA), a universal mobile telecommunications system (UMTS), wireless broadband (WiBro), or a global system for mobile communications (GSM). Furthermore, the wireless communication, for example, may include a short range communication 1864. The short range communication 1864 may include at least one of WI-FI®, BLUETOOTH®, near field communication (NFC), magnetic stripe transmission (MST), or GNSS.

An MST may generate a pulse according to transmission data by using an electromagnetic signal, and the pulse may generate a magnetic field signal. The electronic device 1801 may transmit the magnetic field signal to a point of sales (POS), detect the magnetic field signal by using an MST reader, and restore the data by converting the detected magnetic signal into an electrical signal.

The GNSS may include at least one of, for example, a global positioning system (GPS), a global navigation satellite system (GLONASS), a BEIDOU navigation satellite system (hereinafter, “BEIDOU”), or the European global satellite-based navigation system (GALILEO), according to an in-use area or a bandwidth. Hereinafter, in the present disclosure, the “GPS” may be interchangeably used with the “GNSS”. The wired communication may include at least one of, for example, a universal serial bus (USB), a high definition multimedia interface (HDMI), recommended standard-232 (RS232), and a plain old telephone Service (POTS). The network 1862 may include at least one of communication networks, for example, a computer network (for example, a LAN or a WAN), the Internet, or a telephone network.

The first and second external electronic devices 1802 and 1804 may be the same or different type devices from the electronic device 1801. According to an example embodiment, the server 1806 may include a group of one or more servers. According to various example embodiments of the present disclosure, all or some of the operations executed by the electronic device 1801 may be executed by another or a plurality of electronic devices (for example, the electronic devices 1802 and 1804 or the servers 1806). According to an example embodiment of the present disclosure, when the electronic device 1801 should execute some functions or services automatically or upon request, it may request at least some functions associated with the functions or services from another device (for example, the electronic devices 1802 and 1804 or the server 1806), in place of or in addition to directly executing the functions or services. The other electronic device (for example, the electronic device 1802 or 1804 or the server 1806) may execute a requested function or an additional function, and may transfer the result to the electronic device 1801. The electronic device 1801 may process the received result directly or additionally, and may provide a requested function or service. To this end, for example, the cloud computing, distributed computing, or client-server computing technologies may be used.

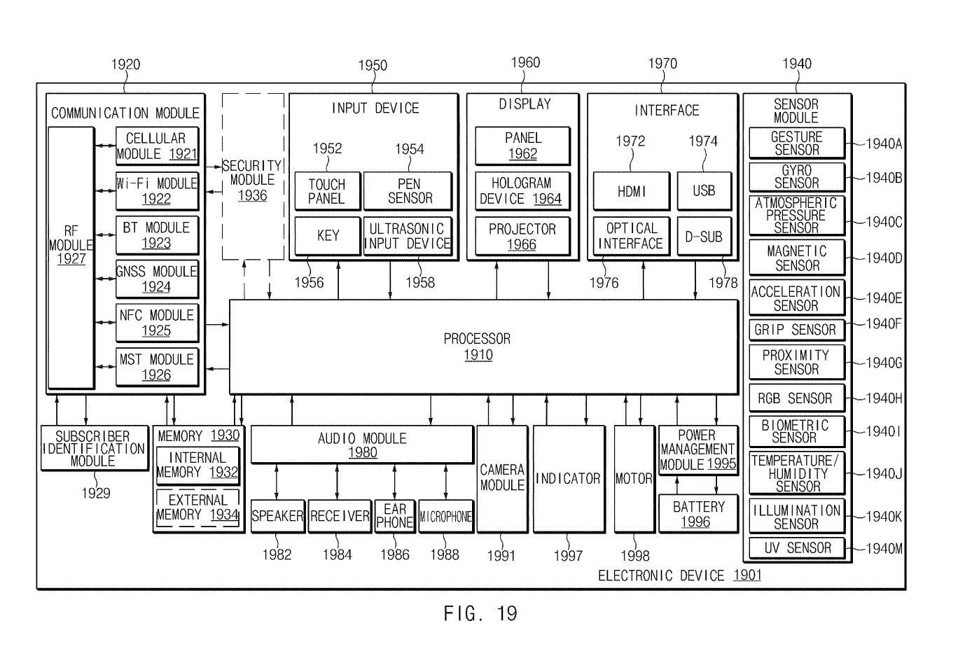

FIG. 19 is a block diagram illustrating an example electronic device 1901 according to various example embodiments.

Referring to FIG. 19, an electronic device 1901 may include, for example, the whole part or a part of the electronic device 1801 illustrated in FIG. 18. Referring to FIG. 1901, the electronic device 31 may include at least one processor (for example, an application processor (AP) 1910), a communication circuit 1920, a subscriber identification circuit (SIM) card 1924, a memory 1930, a sensor circuit 1940, an input device (e.g., including input circuitry) 1950, a display 1960, an interface (e.g., including interface circuitry) 1970, an audio circuit 1980, a camera circuit 1991, a power management circuit 1995, a battery 1996, an indicator 1997, or a motor 1998.

The processor 1910 may control a plurality of hardware or software elements connected to the processor 1910 by driving an operating system or an application program and perform a variety of data processing and calculations. The processor 1910 may be implemented by, for example, a System on Chip (SoC). According to an embodiment, the processor 1910 may further include a graphical processing unit (GPU) and/or an image signal processor. The processor 1910 may include at least some (for example, a cellular circuit 1921) of the elements illustrated in FIG. 19. The processor 1910 may load instructions or data, received from at least one other element (for example, a non-volatile memory), in a volatile memory to process the loaded instructions or data, and may store various types of data in a non-volatile memory.

The communication circuit 1920 may include various communication circuitry and have the same or similar structure to the communication interface 1870 of FIG. 18. The communication circuit 1920 may include various communication circuitry, such as, for example, and without limitation, a cellular circuit 1921, a WI-FI® circuit 1922, a BLUETOOTH® circuit 1923, a GNSS circuit 1924 (for example, a GPS circuit, a GLONASS circuit, a BEIDOU circuit, or a GALILEO circuit), an NFC circuit 1925, and a radio frequency (RF) circuit 1926.

The cellular circuit 1921 may provide a voice call, a video call, a text message service, or an Internet service through, for example, a communication network. According to an embodiment, the cellular circuit 1921 may distinguish between and authenticate electronic devices 1901 within a communication network using a subscriber identification circuit (for example, the SIM card 1929). According to an embodiment, the cellular circuit 1921 may perform at least some of the functions that the processor 1910 may provide. According to an embodiment, the cellular circuit 1921 may include a communication processor (CP).

Each of the WI-FI® circuit 1922, the BLUETOOTH® circuit 1923, the GNSS circuit 1924, the NFC circuit 1925, or the MST circuit 1926, for example, may include a processor for processing data transmitted/received through the corresponding circuit. According to some embodiments, at least some (for example, two or more) of the cellular circuit 1921, the WI-FI® circuit 1922, the BLUETOOTH® circuit 1923, the GNSS circuit 1924, and the MST circuit 1925 may be included in one Integrated Chip (IC) or IC package.

The RF circuit 1927 may transmit/receive, for example, a communication signal (for example, an RF signal). The RF circuit 1927 may include, for example, a transceiver, a power amp module (PAM), a frequency filter, a low noise amplifier (LNA), or an antenna. According to another embodiment, at least one of the cellular circuit 1921, the WI-FI® circuit 1922, the BLUETOOTH® circuit 1923, the GNSS circuit 1924, the NFC circuit 1925, or the MST circuit may transmit and receive an RF signal through a separate RF circuit.

The subscriber identification circuit 1929 may include, for example, a card including a subscriber identification circuit and/or an embedded SIM, and may further include unique identification information (for example, an integrated circuit card identifier (ICCID)) or subscriber information (for example, international mobile subscriber identity (IMSI)).

The memory 1930 (for example, the memory 1830) may include, for example, an internal memory 1932 or an external memory 1934. The internal memory 1932 may include at least one of, for example, a volatile memory (for example, a dynamic random access memory (DRAM), a static RAM (SRAM), a synchronous dynamic RAM (SDRAM), and the like) and a non-volatile memory (for example, a one-time programmable read only Memory (OTPROM), a programmable ROM (PROM), an erasable and programmable ROM (EPROM), an electrically erasable and programmable ROM (EEPROM), a flash memory (for example, a NAND flash memory or a NOR flash memory), a hard driver, or a solid state drive (SSD).

The external memory 1934 may further include a flash drive, for example, a Compact Flash (CF), a Secure Digital (SD), a Micro Secure Digital (Micro-SD), a Mini Secure Digital (Mini-SD), an eXtreme Digital (xD), a memory stick, or the like. The external memory 1934 may be functionally and/or physically connected to the electronic device 1901 through various interfaces.

The security circuit 1936 is a circuit including a storage space having a relatively high security level as compared with the memory 1930, and may be a circuit that guarantees a safe data storage and a protected execution environment. The security circuit 1936 may be implemented by a separate circuit, and may include a separate processor. The security circuit 1936, for example, may be present in a detachable smart chip or a secure digital (SD) card, or may include an embedded secure element (eSE) embedded in a fixed chip of the electronic device 1901. Further, the security circuit 1936 may be driven by an operation system (OS) that is different form t the operating system of the electronic device 1901. For example, the security circuit 1936 may be operated based on a java card open platform (JCOP) operating system.

The sensor circuit 1940 may measure, for example, a physical quantity or detect an operation state of the electronic device 1901, and may convert the measured or detected information to an electrical signal. The sensor circuit 1940 may include at least one of, for example, a gesture sensor 1940A, a gyro sensor 1940B, an atmospheric pressure sensor 1940C, a magnetic sensor 1940D, an acceleration sensor 1940E, a grip sensor 1940F, a proximity sensor 1940G, a color sensor 1940H (for example, red, green, and blue (RGB) sensor), a biometric sensor 1940I, a temperature/humidity sensor 1940J, an illumination sensor 1940K, and a Ultra Violet (UV) sensor 1940M. Additionally or alternatively, the sensor circuit 1940 may include an E-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor circuit 1940 may further include a control circuit for controlling one or more sensors included therein. In some embodiments, the electronic device 1901 may further include a processor configured to control the sensor circuit 1940 as a part of or separately from the processor 1910, and may control the sensor circuit 1940 while the processor 1910 is in a sleep state.

The input device 1950 may include various input circuitry, such as, for example, and without limitation, a touch panel 1952, a (digital) pen sensor 1954, a key 1956, or an ultrasonic input device 1958. The touch panel 1952 may use at least one of, for example, a capacitive type, a resistive type, an infrared type, and an ultrasonic type. The touch panel 1952 may further include a control circuit. The touch panel 1952 may further include a tactile layer, and provide a tactile reaction to a user.

The (digital) pen sensor 1954 may include, for example, a recognition sheet which is a part of the touch panel or a separate recognition sheet. The key 1956 may include, for example, a physical button, an optical key, or a keypad. The ultrasonic input device 1958 may detect ultrasonic waves generated by an input tool through a microphone (for example, a microphone 1988) and may identify data corresponding to the detected ultrasonic waves.

The display 1960 (for example, the display 1860) may include a panel 1962, a hologram device 1964, or a projector 1966. The panel 1962 may include an element equal or similar to the display 1860 of FIG. 18. The panel 1962 may be implemented to be, for example, flexible, transparent, or wearable. The panel 1962 may be formed as a single circuit together with the touch panel 1952. The hologram device 1964 may show a three dimensional image in the air using an interference of light. The projector 1966 may display an image by projecting light onto a screen. The screen may be located, for example, in the interior of or on the exterior of the electronic device 1901. According to an embodiment, the display 1960 may further include a control circuit for controlling the panel 1962, the hologram device 1964, or the projector 1966.

The interface 1970 may include various interface circuitry, such as, for example, and without limitation, a high-definition multimedia interface (HDMI) 1972, a universal serial bus (USB) 1974, an optical interface 1976, or a D-subminiature (D-sub) 1978. The interface 1970 may be included in, for example, the communication interface 1870 illustrated in FIG. 18. Additionally or alternatively, the interface 1970 may include, for example, a mobile high-definition link (MHL) interface, a secure digital (SD) card/multimedia card (MMC) interface, or an infrared data association (IrDA) standard interface.

The audio circuit 1980 may bilaterally convert, for example, a sound and an electrical signal. At least some elements of the audio circuit 1980 may be included in, for example, the input/output interface 1850 illustrated in FIG. 18. The audio circuit 1980 may process voice information input or output through, for example, a speaker 1982, a receiver 1984, earphones 1986, or the microphone 1988.

The camera circuit 1991 is a device which may photograph a still image and a dynamic image. According to an embodiment, the camera module 291 may include one or more image sensors (for example, a front sensor or a back sensor), a lens, an Image Signal Processor (ISP) or a flash (for example, an LED or xenon lamp).

The power management circuit 1995 may manage, for example, power of the electronic device 1901. According to an embodiment of the present disclosure, the power management circuit 1995 may include a Power Management Integrated Circuit (PMIC), a charger Integrated Circuit (IC), or a battery or fuel gauge. The PMIC may have a wired and/or wireless charging scheme. Examples of the wireless charging method may include, for example, a magnetic resonance method, a magnetic induction method, an electromagnetic wave method, and the like. Additional circuits (for example, a coil loop, a resonance circuit, a rectifier, etc.) for wireless charging may be further included. The battery gauge may measure, for example, a residual quantity of the battery 1996, and a voltage, a current, or a temperature while charging. The battery 1996 may include, for example, a rea change in an electric chargeable battery and/or a solar battery.

The indicator 1997 may indicate particular status of the electronic device 1901 or a part thereof (for example, the processor 1910), for example, a booting status, a message status, a charging status, or the like. The motor 1998 may convert an electrical signal into mechanical vibrations, and may generate a vibration or haptic effect. Although not illustrated, the electronic device 1901 may include a processing device (for example, a GPU) for supporting mobile TV. The processing unit for supporting mobile TV may process, for example, media data pursuant to a certain standard of Digital Multimedia Broadcasting (DMB), Digital Video Broadcasting (DVB), or media flow (MEDIAFLO™).

Each of the elements described in the description may include one or more components, and the terms of the elements may be changed according to the type of the electronic device. In various example embodiments of the present disclosure, the electronic device may include at least one of the elements described in the description, and some elements may be omitted or additional elements may be further included. Some of the elements of the electronic device according to various example embodiments of the present disclosure may be coupled to form one entity, and may perform the same functions of the corresponding elements before they are coupled.

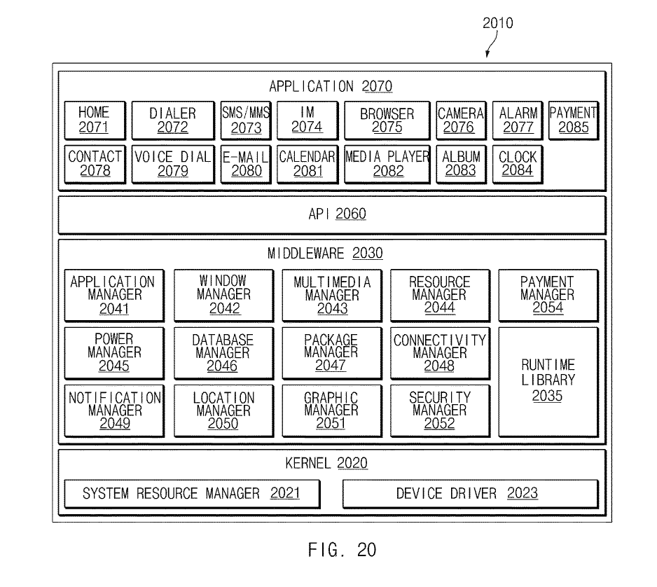

FIG. 20 is a block diagram illustrating an example program module according to various example embodiments.

According to an example embodiment, the program module 2010 (for example, a program 1840) may include an operating system (OS) that controls resources related to an electronic device, and various application programs (for example, an application program 1847) that is driven on an operating system. The operating system may be, for example, ANDROID®, iOS®, WINDOWS®, SYMBIAN OS®, TIZEN®, SAMSUNG BADA®, or the like.

The program module 2010 may include a kernel 2020, a middleware 2030, an API 2060, or applications 2070. At least a part of the program module 2010 may be preloaded on an electronic device or may be downloaded from external electronic devices (for example, external electronic devices 1802 and 1804 and a server 1806).

The kernel 2020 (for example, the kernel 1841) may include, for example, a system resource manager 2021, a device driver 2023, a touch panel driver 2025, and a pen driver 2027. The system resource manager 2021 may control, allocate, or retrieve the system resources. According to one embodiment, the system resource manager 2021 may include a process management unit, a memory management unit, or a file system management unit. The device driver 2023 may include, for example, a display driver, a camera driver, a Bluetooth driver, a shared-memory driver, a USB driver, a keypad driver, a Wi-Fi driver, an audio driver, or an Inter-Process Communication (IPC) driver. The touch panel driver 2025 and the pen driver 2027 may be included in the device driver 2023.

The middleware 2030 may provide a function required by the applications 870 in common or provide various functions to the applications 2070 through the API 2060 so that the applications 2070 can efficiently use limited system resources of the electronic device. According to an example embodiment, the middleware 2030 (for example, the middleware 1843) may include, for example, at least one of a runtime library 2035, an application manager 2041, a window manager 2042, a multimedia manager 2043, a resource manager 2044, a power manager 2045, a database manager 2046, a package manager 2047, a connectivity manager 2048, a notification manager 2049, a location manager 2050, a graphic manager 2051, a security manager 2052, or a payment manager 2054.

The run time library 2035 may include, for example, a library module that a compiler uses in order to add new functions through a programming language while the applications 2070 are executed. The run time library 2035 may perform input/output management, memory management, or a function for an arithmetic function.

The application manager 2041, for example, may manage a lifecycle of at least one of the applications 2070. The window manager 2042 may manage a GUI resource used in a screen. The multimedia manager 2043 may detect a format required for reproducing various media files and encode or decode a media file using a codec appropriate for the corresponding format. The resource manager 2044 may manage resources, such as a source code, a memory, or a storage space, of at least one of the applications 2070.

The power manager 2045 may operate together with, for example, a basic input/output system (BIOS), so as to manage a battery or power and may provide power information required for the operation of the electronic device. The database manager 2046 may generate, search for, or change a database to be used by at least one of the applications 2070. The package manager 2047 may manage the installation or the updating of applications distributed in a package file form.

For example, the connectivity manager 2048 may manage wireless connections, such as WI-FI® or BLUETOOTH®. The notification manager 2049 may display or notify an event such as a received message, an appointment, a proximity notification, and the like to a user without disturbance. The location manager 2050 may manage location information of the electronic device. The graphic manager 2051 may manage graphic effects to be provided to a user and user interfaces related to the graphic effects. The security manager 2052 may provide various security functions required for system security or user authentication. According to an embodiment of the present disclosure, when the electronic device (for example, the electronic device 1801) has a phone function, the middleware 2030 may further include a telephony manager for managing a voice or video communication function of the electronic device.

The middleware 2030 may include a middleware module for forming a combination of various functions of the aforementioned elements. The middleware 2030 may provide modules specialized according to the type of OS in order to provide differentiated functions. In addition, some existing elements may be dynamically removed from the middleware 2030, or new elements may be added to the middleware 2030.

The API 2060 (for example, the API 1845) is, for example, a set of API programming functions, and may be provided another configuration according to an operating system. For example, for each platform, one API set may be provided in a case of Android or iOS, and two or more API sets may be provided in a case of Tizen.

The application 2070 (for example, the application program 1847) may include, for example, a home 2071, a dialer 2072, an SMS/MMS 2073, an instant message (IM) 2074, a browser 2075, a camera 2076, an alarm 2077, a contact 2078, a voice dial 2079, an e-mail 2080, a calendar 2081, a media player 2082, an album 2083, a clock 2084, a payment 2085 or at least one application that may provide health care (for example, measuring an exercise degree or blood glycose) or environmental information.

According to an example embodiment, the application 2070 may include an application (hereinafter, referred to as “an information exchange application for convenience of description) that supports exchange of information between the electronic device (for example, the electronic device 1801) and external electronic device (for example, the external electronic device 1802 and 1804). The information exchange application may include, for example, a notification relay application for forwarding specific information to an external electronic device, or a device management application for managing an external electronic device.

For example, the notification relay application may have a function of forwarding, to external electronic devices (for example, the electronic devices 1802 and 1804), notification information generated from other applications of the electronic device (for example, an SMS/MMS application, an e-mail application, a health care application, and an environmental information application). The notification relay application may receive notification information from, for example, an external electronic device and provide the received notification information to a user.

The device management application may, for example, manage (for example, install, delete, or update) a function for at least a part of an external electronic device (for example, the electronic device 1802 or 1804) communicating with the electronic device 18 (for example, activating/deactivating the external electronic device itself (or some components thereof) or adjusting the brightness (or resolution) of a display), an application operating in the external electronic device, or a service provided from the external electronic device (for example, a telephone call service or a message service).

According to an example embodiment, the application 2070 may include an application (for example, a health management application) designated according to an attribute of an external electronic device (for example, an electronic device 1802 or 1804). According to an example embodiment, the application 2070 may include an application that is received from an external electronic device (for example, the server 1806 or the device 1802 or 1804). According to an example embodiment of the present disclosure, the applications 2070 may include a preloaded application or a third party application that is downloaded from a server. The names of the elements of the program module 2010 according to the illustrated embodiment may vary according to the type of the operating system.

According to various example embodiments, at least a part of the program module 2010 may be implemented by software, firmware, hardware (e.g., circuitry), or two or more combinations thereof. At least a part of the program module 2010, for example, may be implemented (for example, executed) by a processor (for example, the processor 1910). At least a part of the program module 2010 may include, for example, a module, a program routine, a set of instructions, or a process for performing at least one function.

The term “module” used in the description may refer, for example, to a unit including, for example, one of hardware (e.g., circuitry), software, or firmware or a combination of the two or more of them. The module may be interchangeably used, for example, with a unit, logic, a logical block, a component, or a circuit. The module may be a minimum unit or a part of an integrally configured part. The module may be a minimum unit or a part which performs one or more functions. The module may be implemented mechanically or electromagnetically. For example, the module may include at least one of processing circuitry, an application-specific integrated circuit (ASIC) chip, a field-programmable gate array, or a programmable-logic device, which has been known, will be developed in the future, or performs certain operations.

At least some of the devices (for example, modules or functions) or methods (for example, operations) according to various example embodiments of the present disclosure may be implemented by an instruction stored in a computer-readable storage medium, for example, in the form of a program module. When the instruction is executed by the processor (for example, the processor 1820), the at least one processor may perform a function corresponding to the instruction. The computer-readable storage medium may be, for example, a memory 1830.

The computer-readable storage medium may include a hard disk, a floppy disk, a magnetic medium (for example, a magnetic tape), an optical medium (for example, a compact disk read only memory (CD-ROM)), a digital versatile disk (DVD), a magneto-optical medium (for example, a floptical disk), a hardware device (for example, a read only memory (ROM), a random access memory (RAM), or a flash memory). Further, the program instructions may include high-level language codes which may be executed by a computer using an interpreter as well as machine languages created by using a compiler. The above-mentioned hardware device may be configured to be operated as one or more software module to perform operations of various example embodiments, and the converse is true.

The module or program module according to various example embodiments of the present disclosure may include at least one of the above-mentioned elements, omit some of them, or further include other elements. The module, the program module, or the operations performed by other elements according to various example embodiments of the present disclosure may be performed in a sequential, parallel, iterative, or heuristic method. Further, some operations may be executed in another sequence or may be omitted, or other operations may be added.

According to various example embodiments of the present disclosure, as a contact unit connected with a ground is arranged to contact an insulating member of an external connector, it may be possible to prevent and/or reduce degradation in the quality of an audio signal due to a switch between the ground and the contact.

Also, as widths of a metal area and a nonmetal area of a connector receiving a balanced audio signal are changed, there may be provided the connector in which the nonmetal area is connected with the ground and the metal area receives the balanced audio signal.

Although the present disclosure has been described with reference to various example embodiments, various changes and modifications may be suggested to one skilled in the art. It is intended that the present disclosure encompass such changes and modifications as fall within the scope of the appended claims.

What is claimed is:

1. An electronic device comprising:
an audio jack configured to receive an audio plug comprising a plurality of terminals and a plurality of insulating members arranged among the plurality of terminals; the audio jack comprising a plurality of contacts configured to contact at least one of the plurality of terminals or the plurality of insulating members;
a circuit that is electrically connected with the plurality of contacts and configured to send an audio signal to the audio plug; and
a processor configured to control the circuit,
wherein at least one of the plurality of contacts is electrically connected with a ground and is configured to contact one of the plurality of insulating members of the audio plug if the audio plug is matched with the audio jack.

2. The electronic device of claim 1, wherein the circuit or the processor is configured to determine a type of the audio plug through at least one of the plurality of contacts and to send an output signal to at least one of the plurality of terminals of the audio plug based on the type of the audio plug.

3. The electronic device of claim 2, wherein the circuit or the processor is configured to determine the type of the audio plug through a contact, which is electrically connected with the ground, from among the plurality of contacts.

4. The electronic device of claim 3, wherein the circuit or the processor is configured to determine the audio plug to be a plug of a first type if the contact electrically connected with the ground contacts the insulating member and to determine the audio plug to be a plug of a second type if the contact electrically connected with the ground contacts the terminal.

5. The electronic device of claim 3, wherein the circuit or the processor is configured to send an unbalanced audio signal to the audio plug if the contact electrically connected with the ground contacts the terminal and to send a balanced audio signal to the audio plug if the contact electrically connected with the ground contacts the insulating member.

6. The electronic device of claim 3, wherein the audio jack comprises one or more detecting contacts configured to measure an impedance of at least some of the plurality of terminals or the plurality of insulating members, and
wherein the circuit or the processor is configured to determine the type of the audio plug based on the impedance measured through the detecting contact.

7. The electronic device of claim 1, wherein the circuit comprises:
a digital-analog converter configured to send an output signal to the audio plug; and
an analog-digital converter configured to receive an input signal from the audio plug.

8. The electronic device of claim 7, wherein the circuit is configured to receive the input signal through the analog-digital converter if the input signal is received from one of the plurality of terminals and to send the output signal through the digital-analog converter if the input signal is not received from one of the plurality of terminals.

9. The electronic device of claim 7, wherein the circuit further comprises:
a switch configured to selectively connect the digital-analog converter or the analog-digital converter with one of the plurality of contacts.

10. The electronic device of claim 7, wherein the audio jack comprises:
a first contact configured to receive the input signal from an audio plug capable of receiving an unbalanced audio signal and a second contact configured to receive the input signal from an audio plug capable of receiving a balanced audio signal; and
wherein the circuit is configured to receive the input signal from the first contact or the second contact through the analog-digital converter.

11. The electronic device of claim 1, wherein the audio jack is a 3.5π jack that receives an earphone plug.

12. The electronic device of claim 1, wherein the audio jack is configured to receive one of a first type plug capable of receiving a balanced audio signal or a second type plug capable of receiving an unbalanced audio signal, and
wherein at least one of the plurality of contacts is configured to contact one of a plurality of insulating members of the first type plug if the first type plug is received in the audio jack and to contact one of a plurality of terminals of the second type plug if the second type plug is received in the audio jack.

13. An electronic device comprising:
an audio jack configured to receive a first type audio plug capable of receiving a balanced audio signal or a second type audio plug capable of receiving an unbalanced audio signal, the audio jack comprising a plurality of contacts capable of contacting a plurality of terminals or a plurality of insulating members included in the first type audio plug or the second type audio plug;
a circuit that is electrically connected with the plurality of contacts and configured to send the balanced audio signal or the unbalanced audio signal to an audio plug matched with the audio jack; and
a processor configured to control the circuit,
wherein the plurality of contacts comprise a ground contact electrically connected with a ground,
wherein the ground contact is configured to contact one of a plurality of insulating members included in the first type audio plug if the first type audio plug is matched with the audio jack and to contact one of a plurality of terminals included in the second type audio plug if the second type audio plug is matched with the audio jack, and
wherein the circuit is configured to provide the balanced audio signal to the first type audio plug if the ground contact contacts one of the plurality of insulating members and to provide the unbalanced audio signal to the second type audio plug if the ground contact contacts one of the plurality of terminals.

14. The electronic device of claim 13, wherein the circuit is configured to send an output signal to one of the plurality of terminals if an input signal is received from one of the plurality of terminals or if the input signal is not received from one of the plurality of terminals.

15. The electronic device of claim 13, wherein the circuit comprises:
a digital-analog converter configured to send an output signal to the first type audio plug or the second type audio plug; and
an analog-digital converter configured to receive an input signal from the first type audio plug or the second type audio plug.

16. The electronic device of claim 15, wherein the circuit is configured to receive the input signal through the analog-digital converter if the input signal is received from one of the plurality of terminals and to send the output signal through the digital-analog converter if the input signal is not received from one of the plurality of terminals.

17. The electronic device of claim 15, wherein the circuit further comprises:
a switch configured to selectively connect the digital-analog converter or the analog-digital converter with one of the plurality of contacts.

18. A method of outputting an audio signal of an electronic device, the method comprising:
obtaining a signal for measuring impedance of a terminal or an insulating member of an external connector;
determining whether a value of the impedance is included in a specific range, based on the signal; and
sending a balanced audio signal to the external connector if the value of the impedance is included in the specific range and sending an unbalanced audio signal to the external connector if the value of the impedance is not included in the specific range.

19. The method of claim 18, further comprising:
detecting an input signal from a microphone terminal of the external connector; and
receiving the input signal through an analog-digital converter if the input signal is detected.

20. The method of claim 18, wherein the determining comprises determining the external connector to be a connector for the balanced audio signal if the value of the impedance is included in the specific range and determining the external connector to be a connector for the unbalanced audio signal if the value of the impedance is not included in the specific range.
